(19) United States
(12) Patent Application Publication
(10) Pub. No.: US 2024/0268377 A1
(43) Pub. Date: Aug. 15, 2024

(54) AGROCHEMICAL COMPOSITION CONTAINING A PARTICULAR COPOLYMER DISPERSANT WITH AT LEAST ONE B-CARBOXYETHYL ACRYLATE MONOMER

(71) Applicant: SPECIALITY OPERATIONS FRANCE, Lyon (FR)

(72) Inventors: Wojciech Bzducha, Courbevoie (FR); Monique Adamy, Asnières-Sur-Seine (FR); Hélène Fay, Valencin (FR); Clara Vernay, Paris (FR)

(73) Assignee: SPECIALTY OPERATIONS FRANCE, Lyon (FR)

(21) Appl. No.: 18/564,482

(22) PCT Filed: May 25, 2022
(86) PCT No.: PCT/EP2022/064282

§ 371 Date: Nov. 27, 2023

(30) Foreign Application Priority Data
May 26, 2021 (EP) 21175976.6

(51) Int. Cl. A01N 25/10; A01N 25/04

(52) U.S. Cl. CPC A01N 25/10; A01N 25/04

(57) ABSTRACT

The present invention relates to agrochemical compositions containing particular copolymer dispersants.

The invention also relates to the use of a copolymer according to the invention as a dispersant in an agrochemical composition, and to the use of the composition according to the invention for the treatment of soils, plants and/or seeds to control pests and/or to regulate the growth of plants.

This application claims priority filed on 26 May 2021 in Europe with Nr 21175976.6, the whole content of this application being incorporated herein by reference for all purposes.

The present invention relates to agrochemical compositions containing particular copolymer dispersants.

The invention also relates to the use of a copolymer according to the invention as a dispersant in an agrochemical composition, and to the use of the composition according to the invention for the treatment of soils, plants and/or seeds to control pests and/or to regulate the growth of plants.

Agrochemical compositions are more and more complex with high loading of active ingredients which may be sparingly soluble, or even insoluble, in water, and/or combo systems combining said active ingredients with several modes of action having different physicochemical characteristics: for example, one active can be in the form of a soluble salt and the other one dispersed in an aqueous phase.

Thus, agrochemical compositions typically include dispersants to improve the dispersion, and in particular to provide homogeneity and to help reduce and/or prevent flocculation and agglomeration.

Dispersion is the process through which agglomerates of solid particles become separated, and a new interface forms between each of the smaller particles and the surrounding media. This process is facilitated by the application of external force (milling) and the use of amphiphilic additives such as dispersants.

Such elaborate systems present high challenges regarding long-term stability and performances at dilution. Strong stability issues are observed with organic agricultural materials that are prone to crystal growth via Ostwald ripening mechanism. In this respect, formulating modern compositions which combine often two, three or more agricultural materials with various physicochemical characteristics can become a real challenge, with little formulation space for the formulator.

Traditional dispersant systems are sometimes not effective enough solution especially for organic agricultural materials prone to crystal growth via Ostwald ripening or combo system with high electrolyte concentration. Even such high performance dispersants are not perfect, and one feature they lack is dispersion stability in high ionic strength media, in particular where another component of the formulation is a water-soluble electrolyte e.g. in combination formulations including water soluble electrolyte herbicide such as bipyridyl herbicides, glufosinate or glyphosate salts, or auxin herbicides, such as 2.4D or dicamba salts.

Thus, there is a continuous need for providing improved compositions for agriculture needs, and in particular for providing robust, improved dispersant polymers with enhanced crystal-growth inhibition properties which are highly effective at reduced dosage, and dispersant polymers that are tolerant to high ionic strength systems, for example in presence of soluble active salts.

These agrochemical compositions should also have good intrinsic properties, in particular good physicochemical properties such as a good stability on storage and a good viscosity, and should present good performances at dilution including good suspensibility of the agricultural material, even for high loading formulations.

These objectives are achieved with the present invention, a subject-matter of which is an agrochemical composition comprising:
(i) at least one copolymer obtainable by radical polymerization of:
   at least the following monomers:
      a) acrylic acid,
      b) at least one β-carboxyethyl (meth)acrylate monomer,
      c) at least one alkyl (meth)acrylate monomer, said alkyl radical comprising from 1 to 12 carbon atoms,
      d) at least one hydrophobic non-acrylic monomer, and
      e) at least one (C₁-C₁₂)alkyloxy polyethylene glycol (meth)acrylate monomer,
   in the presence of a free-radical polymerization initiator; and
(ii) at least one agricultural material.

The agrochemical compositions according to the invention present good intrinsic physicochemical properties.

In addition, it has been noted that the agrochemical compositions according to the invention reduce, or even prevent, crystal growth of dispersed agricultural material, and also guarantee good performances at dilution including a good suspensibility of the agricultural material, even for high loading formulations.

The agrochemical compositions according to the invention present a high storage stability over time.

It has been also noted that the agrochemical compositions according to the invention have a good viscosity and a good dispersion of agricultural materials, which allows easier application onto soils, plants and/or seeds.

In addition, it has been observed that the abovementioned advantages are also attained in high ionic strength media, even where another component of the composition is a water-soluble electrolyte. More particularly, high ionic concentrations do not compromise the chemical or physical stability of the agrochemical compositions according to the invention.

According to a preferred embodiment of the invention, the composition is an agrochemical composition with a high concentration of agricultural material(s). The use of concentrated compositions is in particular advantageous for economic reasons (indeed such compositions making it possible to reduce the total weight of the compositions, and consequently their transport costs), the concentrated composition then being generally diluted to the desired concentration by the final user.

Another subject-matter of the invention is the use of the copolymer (i) as described hereafter, as a dispersant in an agrochemical composition comprising at least one agricultural material.

A subject-matter of the invention is also the use of the agrochemical composition according to the invention, for the treatment of soils, plants and/or seeds to control pests and/or to regulate the growth of plants.

A subject-matter of the invention is also a method for treating soils, plants and/or seeds to control pests and/or to regulate the growth of plants, by applying the composition according to the invention to at least one plant, area adjacent to a plant, soil adapted to support growth of a plant, root of a plant, foliage of a plant, and/or seed adapted to produce a plant.

Other characteristics, aspects and advantages of the invention will emerge even more clearly on reading the description and the example that follows.

In the present description, and unless otherwise indicated:
the expression “at least one” is equivalent to the expression “one or more” and can be replaced therewith;
the expression “between” is equivalent to the expression “ranging from” and can be replaced therewith, and implies that the limits are included;
for the purposes of the present invention, the expression “greater than” and respectively the expression “less than” are intended to mean an open range which is strictly greater, respectively strictly less, and therefore that the limits are not included.

The suspensibility of the agrochemical composition is defined as the percentage in weight of one or more agricultural material(s) remaining in suspension relative to the total weight of compounds after a given time, after the dilution of said composition at a certain % wt in water (CIPAC A or D standard waters), for example at 1% wt in water. The term “good suspensibility” is intended to denote a suspensibility greater than or equal to 70%, in particular greater than or equal to 80%, more particularly greater than or equal to 85%, for example greater than or equal to 90%.

The suspensibility of a composition can for example be determined according to the CIPAC method MT184.

The term “good storage stability” is intended to denote compositions which remain homogeneous (that is to say which exhibit substantially no, or limited, phase separation (sedimentation, syneresis, etc.)) over time, in particular which remain substantially homogeneous when stored for at least one week at 0° C., or for at least 2 weeks at 54° C. or at least 3 months at 45° C. (CIPAC MT 39.3 and MT 46.3 standardized tests).

The term “good viscosity” or “flowable” is intended to denote compositions exhibiting “good flowability”, that is to say compositions of suitable viscosity, for example of viscosity greater than 300 cP (i.e. 300 mPa·s), in particular of viscosity greater than 300 cP (i.e. 300 mPa·s) and less than 10,000 cP (i.e. 10,000 mPa·s), measured at 20 rpm and at 25° C. using a Brookfield RV viscometer. In addition, a shear thinning profile, that is to say a viscosity which decreases when the shear rate increases, is generally required, in order to allow good flowability of the composition. A concentrated agrochemical composition of the invention must in particular remain pumpable.

The term “suitable dispersion” or “good dispersion” is intended to mean a dispersion after dilution in water (CIPAC A or D standard waters) which is homogeneous (that is to say which exhibits substantially no phase separation. (sedimentation, syneresis, etc.)) over time, in particular which remains substantially homogeneous when stored for 30 minutes in a water bath thermostatically controlled at 30° C., preferably for 2 hours in a water bath thermostatically controlled at 30° C. and ideally for 24 hours in a water bath thermostatically controlled at 30° C. (adaptation of the CIPAC MT180 test). Such a dispersion must in particular make it possible to ensure good properties of use of the dispersed compounds.

Crystal growth, by “Ostwald ripening”, generally occurs when smaller crystals (which have a larger surface area than bigger crystals) dissolve in the aqueous phase and the material is transported through the continuous phase, to nucleation sites of bigger crystals. As a result, the crystals of the agricultural material may aggregate and sediment, the composition becomes inhomogeneous; during application, filters and nozzles of the spray equipment can block and the biological efficacy may be reduced.

The particle size D(50) and D(90) values were determined by dynamic light scattering analysis using a Malvern Mastersizer 2000 with Hydro 2000SM attachments running on deionized water. The particle size D(50) and D(90) values corresponding to the particle diameter such as the cumulative undersized volume fraction of particles is respectively equal to 50% and to 90%. From the particle size values obtained, D(50) and D(90) values were readily determined.

The crystalline morphology of the material was assessed by optical microscopy observation. The sample was diluted to a 5%_{w/w} solution in deionized water, and images of crystalline material taken and processed. In some cases, arbitrary line measurements on the resultant image were used to confirm particle size of the crystals.

Should the disclosure of any patents, patent applications, and publications which are incorporated herein by reference conflict with the description of the present application to the extent that it may render a term unclear, the present description shall take precedence.

### The Copolymer:

The agrochemical composition according to the invention comprises at least one copolymer (i) obtainable by radical polymerization of:
at least the following monomers:
   a) acrylic acid,
   b) at least one β-carboxyethyl (meth)acrylate monomer,
   c) at least one alkyl (meth)acrylate monomer, said alkyl radical comprising from 1 to 12 carbon atoms,
   d) at least one hydrophobic non-acrylic monomer, and
   e) at least one (C₁-C₁₂)alkyloxy polyethylene glycol (meth)acrylate monomer,
in the presence of a free-radical polymerization initiator.

In one embodiment, the agrochemical composition according to the invention comprises at least one copolymer of at least the following monomers:
a) acrylic acid,
b) at least one β-carboxyethyl (meth)acrylate monomer,
c) at least one alkyl (meth)acrylate monomer, said alkyl radical comprising from 1 to 12 carbon atoms,
d) at least one hydrophobic non-acrylic monomer, and
e) at least one (C₁-C₁₂)alkyloxy polyethylene glycol (meth)acrylate monomer.

Preferably, the copolymer (i) comprises from 0.1 to 15 mol. % of units from acrylic acid a); more preferentially from 0.5 to 10 mol. %; and even more preferentially from 1 to 8 mol. %.

Preferably, the β-carboxyethyl (meth)acrylate monomer(s) b) are of the following formula (I):

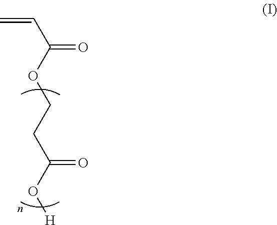

wherein n is an integer ranging from 1 to 5.

The monomer b) has been described for example in WO 2012/072911.

In a preferred embodiment, the at least one β-carboxyethyl (meth)acrylate monomer b) is a mixture of different β-carboxyethyl (meth)acrylate monomers of the above formula (I) with n ranging from 1 to 5.

Preferably, the copolymer (i) comprises from 1 to 35 mol. % of units from β-carboxyethyl (meth)acrylate b); more preferentially from 5 to 30 mol. %; and even more preferentially from 6 to 25 mol. %.

Preferably, the alkyl (meth)acrylate monomer(s) c) with an alkyl radical comprising from 1 to 12 carbon atoms are chosen from (C₁-C₁₂)alkyl acrylates.

More preferentially, the (C₁-C₁₂)alkyl (meth)acrylate monomer(s) c) are chosen from (C₄-C₁₀)alkyl acrylates; and even more preferentially from (C₆-C₈)alkyl acrylates.

According to a particularly preferred embodiment, the (C₁-C₁₂)alkyl (meth)acrylate monomer c) is 2-ethylhexyl acrylate.

Advantageously, the alkyl (meth)acrylate monomer(s) c) with an alkyl radical comprising from 1 to 12 carbon atoms are not polyoxyalkylenated, and more particularly the alkyl (meth)acrylate monomer(s) c) are not polyoxyethylenated nor polyoxypropylenated.

It is understood that the alkyl (meth)acrylate monomer(s) c) are different from the β-carboxyethyl (meth)acrylate monomer(s) b) according to the invention.

Preferably, the copolymer (i) comprises from 5 to 40 mol. % of units from alkyl (meth)acrylate c); more preferentially from 10 to 30 mol. %; and even more preferentially from 15 to 25 mol. %.

The hydrophobic non-acrylic monomer(s) d) may be selected from any non-acrylic monomer which is water insoluble. More particularly, the solubility of these monomers d) is less than 0.5% in water at 25° C. and at atmospheric pressure (1.013×10⁵ Pa).

For the purpose of the invention, the term “non-acrylic monomer” is intended to mean a monomer which does not contain any acrylic acid, acrylate, methacrylic acid and/or methacrylate moiety.

Preferably, the hydrophobic non-acrylic monomer(s) d) may be chosen from:
vinylaromatic monomers such as styrene, styrenes substituted with one or more C₁-C₆ alkyl groups, vinylnaphthalenes, vinylnaphthalenes substituted with one or more C₁-C₆ alkyl groups, and vinyltoluenes,
vinyl acetate,
vinyl esters of branched or unbranched saturated monocarboxylic acids containing from 1 to 12 carbon atoms, for instance vinyl propionate, vinyl “Versatate” (registered brand name for branched C₉-C₁₁ acid esters) and in particular for the vinyl neodecanoate known as Veova 10, vinyl pivalate, vinyl butyrate, vinyl 2-ethylhexylhexanoate or vinyl laurate;
mono- or diesters of unsaturated dicarboxylic acids containing from 4 to 6 carbon atoms with alkanols containing 1 to 10 carbon atoms, for instance methyl, ethyl, butyl or ethylhexyl maleate or fumarate; and
α-olefins containing from 6 to 20 carbon atoms and preferably from 8 to 14 carbon atoms, such as those available from Chevron Phillips under the tradename AlphaPlus.

More preferentially, the hydrophobic non-acrylic monomer(s) d) are chosen from vinyl aromatic monomers; and even more preferentially from styrene, styrenes substituted with one or more C₁-C₆ alkyl groups, vinylnaphthalenes, vinylnaphthalenes substituted with one or more C₁-C₆ alkyl groups, and mixtures thereof.

Even better, the hydrophobic non-acrylic monomer d) is styrene.

Preferably, the copolymer (i) comprises from 30 to 60 mol. % of units from hydrophobic non-acrylic monomer d); more preferentially from 35 to 50 mol. %; and even more preferentially from 40 to 45 mol. %.

Preferably, the (C₁-C₁₂)alkyloxy polyethylene glycol (meth)acrylate monomer(s) e) are (C₁-C₄)alkyloxy polyethylene glycol (meth)acrylate monomer(s).

More preferentially, the (C₁-C₁₂)alkyloxy polyethylene glycol (meth)acrylate monomer(s) e) are methoxy polyethylene glycol (meth)acrylate monomer(s) (MPEGMA).

According to a preferred embodiment of the invention, the (C₁-C₁₂)alkyloxy polyethylene glycol (meth)acrylate monomer(s) e) are of the following formula (II):

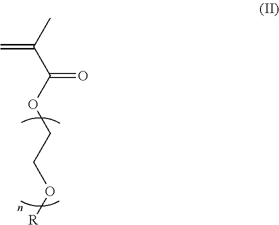

wherein n is an integer ranging from 3 to 30 and R denotes an alkyl group, linear or branched, containing from 1 to 12 carbon atoms.

Preferably, the number n of ethylene glycol unit of the (C₁-C₁₂)alkyloxy polyethylene glycol (meth)acrylate monomer e) ranges from 10 to 20.

More preferentially, the (C₁-C₁₂)alkyloxy polyethylene glycol (meth)acrylate monomer(s) e) are (C₁-C₄)alkyloxy polyethylene glycol (meth)acrylate monomer(s) of formula (II) above, wherein R denotes an alkyl group, linear or branched, containing from 1 to 4 carbon atoms.

Even more preferentially, the (C₁-C₁₂)alkyloxy polyethylene glycol (meth)acrylate monomer(s) e) are methoxy polyethylene glycol (meth)acrylate monomer(s) of formula (II) above, wherein R denotes a methyl.

Preferably, the copolymer (i) comprises from 1 to 30 mol. % of units from (C₁-C₁₂)alkyloxy polyethylene glycol (meth)acrylate e); better from 5 to 25 mol. %; and even better from 10 to 20 mol. %.

More preferentially, the copolymer (i) comprises from 1 to 30 mol. % of units from (C₁-C₄)alkyloxy polyethylene glycol (meth)acrylate e); better from 5 to 25 mol. %; and even better from 10 to 20 mol. %.

Even more preferentially, the copolymer (i) comprises from 1 to 30 mol. % of units from methoxy polyethylene glycol (meth)acrylate e); better from 5 to 25 mol. %; and even better from 10 to 20 mol. %.

According to a particular embodiment of the invention, the monomers used of the polymerization of said copolymer (i) further include a methacrylic acid monomer f).

In other words, according to this embodiment, the copolymer (i) is obtainable by radical polymerization of:
at least the following monomers:
   a) acrylic acid,
   b) at least one β-carboxyethyl (meth)acrylate monomer,
   c) at least one alkyl (meth)acrylate monomer, said alkyl radical comprising from 1 to 12 carbon atoms,
   d) at least one hydrophobic non-acrylic monomer,
   e) at least one (C₁-C₁₂)alkyloxy polyethylene glycol (meth)acrylate monomer, and
   f) methacrylic acid,
in the presence of a free-radical polymerization initiator.

More preferentially according to this embodiment, the copolymer (i) comprises from 0.1 to 20 mol. % of units from methacrylic acid f), for instance from 0.1 to 15 mol %, for instance from 0.1 to 10 mol %, for instance from 0.1 to 5 mol %. In one embodiment, the copolymer (i) comprises from 5 to 20 mol. % of units from methacrylic acid. In another embodiment, the copolymer (i) comprises less than 5 mol %, for instance less than 2 mol %, for instance less than 1 mol %, of units from methacrylic acid.

Preferably, the copolymer (i) has a weight average molecular weight (Mw) less than or equal to 20 000 g/mol.

In particular, the copolymer (i) has a weight average molecular weight (Mw) ranging from 8 000 to 20 000 g/mol.

More preferentially, the copolymer (i) has a weight average molecular weight (Mw) less than or equal to 17 000 g/mol; and even more preferentially ranging from 10 000 to 17 000 g/mol.

Preferably, the copolymer (i) has a number average molecular weight (Mn) less than or equal to 10 000.

In particular, the copolymer (i) has a number average molecular weight (Mn) ranging from 4 000 to 10 000.

More preferentially, the copolymer (i) has a number average molecular weight (Mn) less than or equal to 8 000 g/mol; and even more preferentially ranging from 5 000 to 8 000 g/mol.

The polydispersity index (PDI) is used as a measure of broadness of molecular weight distribution of a polymer. The larger the PDI, the broader the distribution. In a manner known per se, the PDI of a polymer is calculated as the ratio of weight average (Mw) by number average (Mn) molecular weight, in accordance with the following formula:

PDI=Mw/Mn

Preferably, the polydispersity index of copolymer (i) as described previously ranges from 1 to 3.5; more preferentially from 1.5 to 3; and even more preferentially from 2 to 2.5.

According to a preferred embodiment of the invention, the copolymer (i) is free of unit from strong acid derivatives of (meth)acrylic acid monomers.

Strong acid derivatives of (meth)acrylic acid, may include for instance strong acids comprising sulphate acid or sulphonic acid groups (or their salts). Examples of such monomers include sodium methallyl sulphonate, sodium styrene sulphonate, acrylamido methyl propyl sulphonate (AMPS) and (meth)acrylic acid isethionate.

More preferentially according to this embodiment, the copolymer (i) is free of units from 2-acrylamido-2-methylpropane sulfonic acid, sodium methallyl sulphonate, sodium styrene sulphonate and/or (meth)acrylic acid isethionate.

For the purpose of the invention, the term “free of unit from strong acid derivatives of (meth)acrylic acid monomers” is intended to mean that the copolymer (i) contains less than 0.1 mol. % of units resulting from the radical polymerization of at least strong acid derivatives of (meth)acrylic acid monomers, and more preferentially less than 0.01 mol. %, and even more preferentially the copolymer (i) does not contain at all (0% mol) units resulting from the radical polymerization of at least strong acid derivatives of (meth)acrylic acid monomers.

More preferentially according to this embodiment, the copolymer (i) contains less than 0.1 mol. %, and even more preferentially less than 0.01 mol. %, of units from 2-acrylamido-2-methylpropane sulfonic acid, sodium methallyl sulphonate, sodium styrene sulphonate and/or (meth)acrylic acid isethionate monomers. Even more preferentially the copolymer (i) does not contain at all (0% mol) units resulting from 2-acrylamido-2-methylpropane sulfonic acid, sodium methallyl sulphonate, sodium styrene sulphonate and/or (meth)acrylic acid isethionate monomers.

According to a particularly preferred embodiment of the invention, the copolymer (i) is obtainable by radical polymerization of:
the following monomers only:
   a) acrylic acid,
   b) at least one β-carboxyethyl (meth)acrylate monomer,
   c) at least one alkyl (meth)acrylate monomer, said alkyl radical comprising from 1 to 12 carbon atoms,
   d) at least one hydrophobic non-acrylic monomer, and
   e) at least one (C₁-C₁₂)alkyloxy polyethylene glycol (meth)acrylate monomer,
   f) optionally methacrylic acid monomer,
in the presence of a free-radical polymerization initiator.

For the purpose of the invention, the term “of the following monomers only” is intended to mean that the copolymer (i) only comprises units obtained from the monomers a) to f) as described above. In other word, according to this embodiment, the copolymer (i) does not contain units from monomers other than monomers a) to f) as described above.

It is understood that the monomers a) to f) are different from each other.

The copolymers (i) used in the present invention are obtainable by radical polymerization of at least monomers a) to e) as described previously in the presence of a free-radical polymerization initiator.

The free-radical polymerization initiator which can be used for the radical polymerization may be chosen from any source of free radicals which is known per se as being suitable for polymerization processes.

The radical polymerization initiator may, for example, be selected from the following initiators:
peroxyoctoate, t-butyl peroxyneodecanoate, t-butyl peroxyisobutyrate, lauroyl peroxide, t-amyl peroxypivalate, t-butyl peroxypivalate, dicumyl peroxide, benzoyl peroxide, potassium persulfate, ammonium persulfate,
azo compounds such as: 2-2′-azobis(isobutyronitrile), 2,2′-azobis(2-butanenitrile), 4,4′-azobis(4-pentanoic acid), 1 azobis(cyclohexanecarbonitrile), 2-(t-butylazo)-2-cyanopropane, 2,2′-azobis[2-methyl-N-(1,1)-bis(hydroxymethyl)-2-hydroxyethyl]propionamide, 2,2′-azobis(2-methyl-N-hydroxyethyl]propionamide, 2,2′-azobis(N,N′-dimethyleneisobutyramidine)dichloride, 2,2′-azobis(2-amidinopropane)dichloride, 2,2′-azobis(N,N′-dimethyleneisobutyramide), 2,2′-azobis(2-methyl-N-[1,1-bis(hydroxymethyl)-2-hydroxyethyl]propionamide), 2,2′-azobis(2-methyl-N-[1,1-bis(hydroxymethyl)ethyl]propionamide), 2,2′-azobis[2-methyl-N-(2-hydroxyethyl)propionamide] or 2,2′-azobis(isobutyramide)dihydrate,
redox systems comprising combinations such as:

mixtures of hydrogen peroxide, alkyl peroxide, peresters, percarbonates and the like and any iron salts, titanous salts, zinc formaldehyde sulfoxylate or sodium formaldehyde sulfoxylate, and reducing sugars, alkali metal or ammonium persulfates, perborate or perchlorate in combination with an alkali metal bisulfite, such as sodium metabisulfite, and reducing sugars, and alkali metal persulfates in combination with an arylphosphinic acid, such as benzenephosphonic acid and the like, and reducing sugars.

According to one advantageous embodiment, use may be made of a radical initiator of redox type, which has the advantage of not requiring specific heating of the reaction medium (no thermal initiation). It is typically a mixture of at least one medium soluble oxidizing agent with at least one medium soluble reducing agent.

The oxidizing agent present in the redox system may be selected, for example, from peroxides such as: hydrogen peroxide, tert-butyl hydroperoxide, cumene hydroperoxide, t-butyl peroxyacetate, t-butyl peroxybenzoate, t-butyl peroxyoctoate, t-butyl peroxyneodecanoate, t-butyl peroxyisobutyrate, lauroyl peroxide, t-amyl peroxypivalate, t-butyl peroxypivalate, dicumyl peroxide, benzoyl peroxide, sodium persulfate, potassium persulfate, ammonium persulfate or potassium bromate.

The reducing agent present in the redox system may typically be selected from sodium formaldehyde sulfoxylate (in particular in dihydrate form, known under the name Rongalit, or in the form of an anhydrite), ascorbic acid, erythorbic acid, sulfites, bisulfites or metasulfites (in particular alkali metal sulfites, bisulfites or metasulfites), nitrilotrispropionamides, and tertiary amines and ethanolamines (which are preferably water-soluble).

Possible redox systems comprise combinations such as:
mixtures of water-soluble persulfates with water-soluble tertiary amines mixtures of water-soluble bromates (for example alkali metal bromates) with water-soluble sulfites (for example alkali metal sulfites),
mixtures of hydrogen peroxide, alkyl peroxide, peresters, percarbonates and the like and any iron salts, titanous salts, zinc formaldehyde sulfoxylate or sodium formaldehyde sulfoxylate, and reducing sugars, alkali metal or ammonium persulfates, perborate or perchlorate in combination with an alkali metal bisulfite, such as sodium metabisulfite, and reducing sugars, and alkali metal persulfates in combination with an arylphosphinic acid, such as benzenephosphonic acid and the like, and reducing sugars.

An advantageous redox system comprises (and preferably consists of) for example a combination of ammonium persulfate and sodium formaldehyde sulfoxylate.

Preferably, the copolymers (i) used in the present invention are obtainable by controlled radical polymerization of at least monomers a) to e) as described previously in the presence of a radical polymerization control agent and a free-radical polymerization initiator.

The free-radical polymerization initiator may be chosen from the free-radical polymerization initiators described above.

The radical polymerization control agents which can be used for the controlled radical polymerization may especially have the formula (III) below:

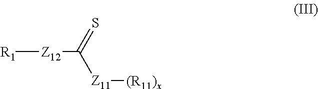

in which:
   Z₁₁ represents C, N, O, S or P,
   Z₁₂ represents S or P,
   R₁₁ represents:
      an optionally substituted alkyl, acyl, aryl, alkene or alkyne group (i), or
      a saturated or unsaturated, optionally substituted or aromatic carbon-based ring (ii), or
      a saturated or unsaturated, optionally substituted heterocycle (iii), these groups and rings (i), (ii) and (iii) possibly being substituted with substituted phenyl groups, substituted aromatic groups or groups: alkoxycarbonyl or aryloxycarbonyl (—COOR), carboxyl (—COOH), acyloxy (—O₂CR), carbamoyl (—CONR₂), cyano (—CN), alkylcarbonyl, alkylarylcarbonyl, arylcarbonyl, arylalkylcarbonyl, phthalimido, maleimido, succinimido, amidino, guanidimo, hydroxyl (—OH), amino (—NR₂), halogen, allyl, epoxy, alkoxy (—OR), S-alkyl, S-aryl, groups of hydrophilic or ionic nature such as the alkali metal salts of carboxylic acids, the alkali metal salts of sulphonic acid, polyalkylene oxide (PEO or PPO) chains and cationic substituents (quaternary ammonium salts),
R representing an C₁-C₈ alkyl or aryl group,
   x corresponds to the valency of Z₁₁, or alternatively x is 0, in which case Z₁₁ represents a phenyl, alkene or alkyne radical, optionally substituted with an optionally substituted alkyl; acyl; aryl; alkene or alkyne group; an optionally substituted, saturated, unsaturated, or aromatic, carbon-based ring; an optionally substituted, saturated or unsaturated heterocycle; alkoxycarbonyl or aryloxycarbonyl (—COOR); carboxyl (COOH); acyloxy (—O₂CR); carbamoyl (—CONR₂); cyano (—CN); alkylcarbonyl; alkylarylcarbonyl; arylcarbonyl; arylalkylcarbonyl; phthalimido; maleimido; succinimido; amidino; guanidimo; hydroxyl (—OH); amino (—NR₂); halogen; allyl; epoxy; alkoxy (—OR), S-alkyl; S-aryl groups; groups of hydrophilic or ionic nature such as the alkali metal salts of carboxylic acids, the alkali metal salts of sulphonic acid, polyalkylene oxide (PEO or PPO) chains and cationic substituents (quaternary ammonium salts); and
   R₁ represents:
      an optionally substituted alkyl, acyl, aryl, aralkyl, alkene or alkyne group saturated or unsaturated, aromatic, optionally substituted carbocycle or heterocycle, or a polymer chain.
R₁, when substituted, may be substituted with optionally substituted phenyl groups, optionally substituted aromatic groups, saturated or unsaturated carbocycles, saturated or unsaturated heterocycles, or groups selected from the following: alkoxycarbonyl or aryloxycarbonyl (—COOR), carboxyl (—COOH), acyloxy (—O₂CR), carbamoyl (—CONR₂), cyano (—CN), alkylcarbonyl, alkylarylcarbonyl, arylcarbonyl, arylalkylcarbonyl, phthalimido, maleimido, succinimido, amidino, guanidimo, hydroxyl (—OH), amino (—NR₂), halogen, perfluoroalkyl CₙF₂ₙ₊₁, allyl, epoxy, alkoxy (—OR), S-alkyl, S-aryl, groups of hydrophilic or ionic nature such as alkali metal salts of carboxylic acids, alkali metal salts of sulfonic acid, polyalkylene oxide chains (PEO, PPO), cationic substituents (quaternary ammonium salts), R representing an alkyl or aryl group, or a polymer chain.

According to one particular embodiment, R₁ is a substituted or unsubstituted, preferably substituted, alkyl group.

The optionally substituted alkyl, acyl, aryl, aralkyl or alkyne groups to which reference is made in the definition of formula (III) above generally contain 1 to 20 carbon atoms, preferably 1 to 12 and more preferentially 1 to 9 carbon atoms. They may be linear or branched. They may also be substituted with oxygen atoms, in particular in the form of esters or sulfur or nitrogen atoms.

Among the alkyl radicals, mention may be made especially of methyl, ethyl, propyl, butyl, pentyl, isopropyl, tert-butyl, pentyl, hexyl, octyl, decyl or dodecyl radicals.

For the purposes of the present description of formula (III), the alkyne groups are radicals generally containing from 2 to 10 carbon atoms, and contain at least one acetylenic unsaturation, such as the acetylenyl radical.

For the purposes of the present description of formula (III), the acyl groups are radicals generally containing from 1 to 20 carbon atoms with a carbonyl group. Among the aryl radicals which may be used according to the invention, mention may be made in particular of the phenyl radical, optionally substituted especially with a nitro or hydroxyl function.

Among the aralkyl radicals, mention may be made in particular of the benzyl or phenethyl radical, optionally substituted especially with a nitro or hydroxyl function.

When R₁ is a polymer chain, this polymer chain may be derived from a radical or ionic polymerization or derived from a polycondensation.

Advantageously, the radical polymerization control agent is a xanthate compound, for instance O-ethyl-S-(1-methoxycarbonyl ethyl) xanthate of formula (CH₃CH(CO₂CH₃))S(C═S)OCH₂CH₃.

A control agent that is particularly suited to the controlled radical polymerization is the compound sold by the company Solvay under the name Rhodixan®A1.

Preferably, the amount of copolymer(s) (i) in the agrochemical composition according to the invention ranges from 0.001 to 50% by weight, more preferentially from 0.005 to 20% by weight, even more preferentially from 0.01 to 10% by weight; and even more preferentially from 0.1 to 5% by weight, relative to the total weight of the composition.

The present invention also relates to the use of the copolymer (i) as described previously, as a dispersant in an agrochemical composition comprising at least one agricultural material.

### The Agricultural Material

The agrochemical composition according to the invention comprises at least one agricultural material.

As used herein, the term “agricultural material” means an active ingredient used in the practice of farming, including cultivation of the soil for the growing of crops. However, the use of agricultural materials is not limited to application to crops. Agricultural materials may be applied to any surface, e.g., for the purpose of cleaning or aiding or inhibiting growth of a living organism. Other non-crop applications include, but are not limited to, application to an animal, e.g. livestock, application to turf and ornamentals, and application to railroad weed.

Preferably, the agricultural material(s) are chosen from pesticides, antimicrobials, nutrients, biostimulants, plant growth regulators, and mixtures thereof.

For example, pesticides include fungicides, herbicides, insecticides, algicides, moluscicides, miticides, nematicides, and rodenticides.

For example, antimicrobials include germicides, antibiotics, antibacterials, antivirals, antifungals, antiprotozoals, antiparasites.

More preferentially, the agricultural material(s) are selected from fungicides, herbicides, insecticides, algicides, moluscicides, miticides, nematicides, rodenticides, germicides, antibiotics, antibacterials, antivirals, antifungals, antiprotozoals, antiparasites, and mixtures thereof.

Suitable pesticides, antimicrobials, plant growth regulators, nutrients and biostimulants for use in the composition according to the invention may be chosen from those cited in the international application WO 2019/185851 from CRODA.

The term ‘pesticide’ will be understood to refer to any substance or mixture of substances intended for preventing, destroying, repelling, or mitigating any pest. A pesticide may be a chemical substance, a biological agent (such as a macroorganisms, a microorganisms), a semiochemicals (such as pheromone) or natural substances of mineral, plant or animal origin used against pests including insects, plant pathogens, weeds, mollusks, birds, mammals, fish, nematodes (roundworms) and microbes that compete with humans for food, destroy property, spread disease or are a nuisance. Pesticides includes biopesticides. The skilled worker is familiar with such pesticides, which can be found, for example, in the Pesticide Manual, 16th Ed. (2013), The British Crop Protection Council, London. In the following examples, pesticides suitable for the agrochemical compositions according to the present invention are given.

Preferably, according to the invention, the pesticides are chosen from insecticides, fungicides, herbicides, miticides, and mixtures thereof.

A fungicide refers to any substance or mixture of substances used to prevent the spread of fungi in gardens and crops. Fungicides are also used to fight fungal infections. Fungicides can either be contact or systemic. A contact fungicide kills fungi when it comes into contact with the fungicide retained on leaf surfaces. A systemic fungicide is absorbed into plant tissues and kills the fungus when it attempts to invade the host.

Examples of fungicides that can be employed in the present disclosure include, but are not limited to: (3-ethoxypropyl)-mercury bromide, 2-methoxyethylmercury chloride, 2-phenylphenol, 8-hydroxyquinoline sulfate, 8-phenylmercurioxyquinoline, acibenzolar, acibenzolar-S-methyl, acypetacs, acypetacs-copper, acypetacs-zinc, aldimorph, allyl alcohol, ametoctradin, amisulbrom, ampropylfos, anilazine, aurcofungin, azaconazole, azithiram, azoxystrobin, barium polysulfide, benalaxyl, benalaxyl-M, benodanil, benomyl, benquinox, bentaluron, benthiavalicarb, benthiavalicarb-isopropyl, benzalkomum chloride, benzamacril, benzamacril-isobutyl, benzamorf, benzohydroxamic acid, bethoxazin, binapacryl, biphenyl, bitertanol, bithionol, bixafen, blasticidin-S, Bordeaux mixture, boscalid, bromuconazole, bupirimate, Burgundy mixture, buthiobate, butylamine, calcium polysulfide, captafol, captan, carbamorph, carbendazim, carboxin, carpropamid, carvone, Cheshunt mixture, chinomethionat, chlobenthiazone, chloraniformethan, chloranil, chlorfenazole, chlorodinitronaphthalene, chloroneb, chloropicrin, chlorothalonil, chlorquinox, chlozolinate, climbazole, clotrimazole, copper acetate, copper carbonate, basic, copper hydroxide, copper naphthenate, copper oleate, copper oxychloride, copper silicate, copper sulfate, copper zinc chromate, cresol, cufraneb, cuprobam, cuprous oxide, cyazofamid, cyclafuramid, cycloheximide, cyflufenamid, cymoxanil, cypendazole, cyproconazole, cyprodinil, dazomet, dazomet-sodium, DBCP, debacarb, decafentin, dehydroacetic acid, dichlofluanid, dichlone, dichlorophen, dichlozoline, diclobutrazol, diclocymet, diclomezine, diclomezine-sodium, dicloran, diethofencarb, diethyl pyrocarbonate, difenoconazole, diflumetorim, dimethirimol, dimethomorph, dimoxystrobin, diniconazole, diniconazole-M, dinobuton, dinocap, dinocap-4, dinocap-6, dinocton, dinopenton, dinosulfon, dinoterbon, diphenylamine, dipyrithione, disulfiram, ditalimfos, dithianon, DNOC. DNOC-ammonium, DNOC-potassium, DNOC-sodium, dodemorph, dodemorph acetate, dodemorph benzoate, dodicin, do dicin-sodium, do dine, drazoxolon, edifenpho s, epoxiconazole, ctaconazole, etem, cthaboxam, cthirimol, ethoxyquin, ethylmercury 2,3-dihydroxypropyl mercaptide, ethylmercury acetate, ethylmercury bromide, ethylmercury chloride, ethylmercury phosphate, etridiazole, famoxadone, fenamidone, fenaminosulf, fenapanil, fenarimol, fenbuconazole, fenfuram, fenhexamid, fenitropan, fenoxanil, fenpiclonil, fenpropidin, fenpropimorph, fentin, fentin chloride, fentin hydroxide, ferbam, ferimzone, fluazinam, fiudioxonil, flumetover, flumorph, fluopicolide, fluopyram, fluoroimide, fluotrimazole, fluoxastrobin, fluquinconazole, flusilazole, flusulfamide, flutianil, flutolanil, flutriafol, fluxapyroxad, folpet, formaldehyde, fo setyl, fo setyl-aluminium, fuberidazole, furalaxyl, furametpyr, furcarbanil, furconazole, furconazole-cis, furfural, furmecyclox, furophanate, glyodin, griseofulvin, guazatine, halacrinate, hexachlorobenzene, hexachlorobutadiene, hexaconazole, hexylthiofos, hydrargaphen, hymexazol, imazalil, imazalil nitrate, imazalil sulfate, imibenconazole, iminoctadine, iminoctadine triacetate, iminoctadine trialbesilate, iodomethane, ipconazole, iprobenfos, iprodione, iprovalicarb, isoprothiolane, isopyrazam, isotianil, isovaledione, kasugamycin, kresoxim-methyl, mancopper, mancozeb, mandipropamid, maneb, mebenil, mecarbinzid, mepanipyrim, mepronil, meptyldinocap, mercuric chloride, mercuric oxide, mercurous chloride, metalaxyl, metalaxyl-M, metam, metam-ammonium, metam-potassium, metam-sodium, metazoxolon, metconazole, methasulfocarb, methfuroxam, methyl bromide, methyl isothiocyanate, methylmercury dicyandiamide, methylmercury benzoate, methylmercury pentachlorophenoxide, metiram, metominostrobin, metrafenone, metsulfovax, milneb, myclobutanil, myclozolin, N-(efhylmercury)-p-toluene-sulphonanilide, nabam, natamycin, nitro styrene, nitrothal-isopropyl, nuarimol, OCH, octhilinone, ofurace, orysastrobin, oxadixyl, oxine-copper, oxpoconazole, oxpoconazole fumarate, oxycarboxin, pefurazoate, penconazole, pencycuron, penflufen, pentachlorophenol, penthiopyrad, phenylmercuriurea, phenylmercury acetate, phenylmercury chloride, phenylmercury derivative of pyrocatechol, phenylmercury nitrate, phenylmercury salicylate, phosdiphen, phthalide, picoxystrobin, piperalin, polycarbamate, polyoxins, polyoxorim, polyoxorim-zinc, potassium azide, potassium polysulfide, potassium thiocyanate, probenazole, prochloraz, procymidone, propamocarb, propamocarb hydrochloride, propiconazole, propineb, proquinazid, prothiocarb, prothiocarb hydrochloride, prothioconazole, pyracarbolid, pyraclostrobin, pyraclostrobin, pyrametostrobin, pyraoxystrobin, pyrazophos, pyribencarb, pyridinitril, pyrifenox, pyrimethanil, pyriofenone, pyroquilon, pyroxychlor, pyroxyfur, quinacetol, quinacetol sulfate, quinazamid, quinconazole, quinoxyfen, quintozene, rabenzazole, salicylanilide, sedaxane, silthiofam, simeconazole, sodium azide, sodium orthophenylphenoxide, sodium pentachlorophenoxide, sodium polysulfide, spiroxamine, streptomycin, sulfur, sultropen, TCMTB, tebuconazole, tebufloquin, tecloftalam, tecnazene, tecoram, tetraconazole, thiabendazole, thiadifluor, thicyofen, thifluzamide, thiochlorfenphim, thiomersal, thiophanate, thiophanate-methyl, thioquinox, thiram, tiadinil, tioxymid, tolclofos-methyl, tolylfluanid, tolylmercury acetate, triadimefon, triadimenol, triamiphos, triarimoi, triazbutil, triazoxide, tributyltin oxide, trichlamide, tricyclazole, tridemorph, trifloxystrobin, triflumizole, triforine, triticonazole, uniconazole, uniconazole-P, validamycin, valifenalate, vinclozolin, zarilamid, zinc naphthenate, zineb, ziram, zoxamide and mixtures thereof.

An herbicide is a pesticide used to kill unwanted plants. Selective herbicides kill specific targets while leaving the desired crop relatively unharmed. Some of these act by interfering with the growth of the weed and are often based on plant hormones. Herbicides used to clear waste ground are non-selective and kill all plant material with which they come into contact. Herbicides are widely used in agriculture and in landscape turf management. They are applied in total vegetation control (TVC) programs for maintenance of highways and railroads. Smaller quantities are used in forestry, pasture systems, and management of areas set aside as wildlife habitat.

Examples of herbicides that can be employed in the present disclosure include, but are not limited to: 4-CPA, 4-CPB, 4-CPP, 2,4-D, 3,4-DA, 2,4-DB, 3,4-DB, 2,4-DEB, 2,4-DEP, 3,4-DP, 2,3,6-TBA, 2,4,5-T, 2,4,5-TB, acetochlor, acifluorfen, aclonifen, acrolein, alachlor, allidochlor, alloxydim, allyl alcohol, alorac, ametridione, ametryn, amibuzin, amicarbazone, amidosulfuron, aminocyclopyrachlor, aminopyralid, amiprofos-methyl, amitrole, ammonium sulfamate, anilofos, anisuron, asulam, atraton, atrazine, azafenidin, azimsulfuron, aziprotryne, barban, BCPC, beflubutamid, benazolin, bencarbazone, benfluralin, benfuresate, bensulfuron, bensulide, bentazone, benzadox, benzfendizone, benzipram, benzobicyclon, benzofenap, benzofiuor, benzoylprop, benzthiazuron, bicyclopyrone, bifenox, bilanafos, bispyribac, borax, bromacil, bromobonil, bromobutide, bromofenoxim, bromoxynil, brompyrazon, butachlor, butafenacil, butamifos, butenachlor, buthidazole, buthiuron, butralin, butroxydim, buturon, butylate, cacodylic acid, cafenstrole, calcium chlorate, calcium cyanamide, cambendichlor, carbasulam, carbetamide, carboxazole chiorprocarb, carfentrazone, CDEA, CEPC, chlomethoxyfen, chloramben, chloranocryl, chlorazifop, chlorazine, chlorbromuron, chlorbufam, chloreturon, chlorfenac, chlorfenprop, chlorflurazole, chlorflurenol, chloridazon, chlorimuron, chlornitrofen, chloropon, chlorotoluron, chloroxuron, chloroxynil, chlorpropham, chlorsulfuron, chlorthal, chlorthiamid, cinidon-ethyl, cinmethylin, cinosulfuron, cisanilide, clethodim, cliodinate, clodinafop, clofop, clomazone, clomeprop, cloprop, cloproxydim, clopyralid, cloransulam, CMA, copper sulfate, CPMF, CPPC, credazine, cresol, cumyluron, cyanatryn, cyanazine, cycloate, cyclosulfamuron, cycloxydim, cycluron, cyhalofop, cyperquat, cyprazine, cyprazole, cypromid, daimuron, dalapon, dazomet, delachlor, desmedipham, desmetryn, diallate, dicamba, dichlobenil, dichloralurca, dichloiTnate, dichlorprop, dichlorprop-P, diclofop, diclosulam, diethamquat, diethatyl, difenopenten, difenoxuron, difenzoquat, diflufenican, diflufenzopyr, dimefuron, dimepiperate, dimethachlor, dimethametryn, dimethenamid, dimethenamid-P, dimexano, dimidazon, dinitramine, dinofenate, dinoprop, dinosam, dinoseb, dinoterb, diphenamid, dipropetryn, diquat, disul, dithiopyr, diuron, DMPA, DNOC, DSMA, EBEP, eglinazine, endothal, epronaz, EPTC, erbon, esprocarb, ethalfluralin, ethametsulfuron, cthidimuron, ethiolate, ethofumesate, ethoxyfen, ethoxysulfuron, ctinofen, etnipromid, etobenzanid, EXD, fenasulam, fenoprop, fenoxaprop, fenoxaprop-P, fenoxasulfone, fenteracol, fenthiaprop, fentrazamide, fenuron, ferrous sulfate, flamprop, flamprop-M, flazasulfuron, florasulam, fluazifop, fluazifop-P, fluazolate, flucarbazone, flucetosulfuron, fluchloralin, flufenacet, flufenican, flufenpyr, flumetsulam, flumezin, flumiclorac, flumioxazin, flumipropyn, fluometuron, fluorodifen, fluoroglycofen, fluoromidine, fluoronitrofen, fluothiuron, flupoxam, flupropacil, flupropanate, flupyrsulfuron, fluridone, fluorochloridone, fluoroxypyr, flurtamone, fluthiacet, fomesafen, foramsulfuron, fosamine, furyloxyfen, glufosinate, glufosinate-P, glyphosate, halosafen, halosulfuron, haloxydine, haloxyfop, haloxyfop-P, hexachloroacetone, hexaflurate, hexazinone, imazamethabenz, imazamox, imazapic, imazapyr, imazaquin, imazethapyr, imazosulfuron, indanofan, indazifiam, iodobonil, iodomethane, iodo sulfuron, ioxynil, ipazinc, ipfencarbazone, iprymidam, isocarbamid, isocil, isomethiozin, isonoruron, isopolinate, isopropalin, isoproturon, isouron, isoxaben, isoxachlortole, isoxaflutole, isoxapyrifop, karbutilate, ketospiradox, lactofen, lenacil, linuron, MAA, MAMA, MCPA, MCPA-thiocthyl, MCPB, mecoprop, mecoprop-P, medinoterb, mefenacet, mefluidide, mesoprazine, mesosulfuron, mesotrione, metam, metamifop, metamitron, metazachlor, metazosulfuron, metflurazon, methabenzthiazuron, methalpropalin, methazole, methiobencarb, methiozolin, methiuron, methometon, methoprotryne, methyl bromide, methyl isothiocyanate, methyldymron, metobenzuron, metobromuron, metolachlor, meto sulam, metoxuron, metribuzin, metsulfuron, molinate, monalide, monisouron, monochloroacetic acid, monolinuron, monuron, morfamquat, MSMA, naproanilide, napropamide, naptalam, neburon, nicosulfuron, nipyraclofen, nitralin, nitrofen, nitrofluorfen, norflurazon, noruron, OCH, orbencarb, orthodichlorobenzene, orthosulfamuron, oryzalin, oxadiargyl, oxadiazon, oxapyrazon, oxasulfuron, oxaziclomefone, oxyfluorfen, parafluoron, paraquat, pebulate, pelargonic acid, pendimethalin, penoxsulam, pentachlorophenol, pentanochlor, pentoxazone, perfluidone, pethoxamid, phenisopham, phenmedipham, phenmedipham-ethyl, phenobenzuron, phenylmercury acetate, picloram, picolinafen, pinoxaden, piperophos, potassium arsenite, potassium azide, potassium cyanate, pretilachlor, primisulfuron, procyazine, prodiamine, profluazol, profluralin, profoxydim, proglinazine, prometon, prometryn, propachlor, propanil, propaquizafop, propazine, propham, propisochlor, propoxycarbazone, propyrisulfuron, propyzamide, pro sulfalin, prosulfocarb, prosulfuron, proxan, prynachlor, pydanon, pyraclonil, pyraflufen, pyrasulfotole, pyrazolynate, pyrazosulfuron, pyrazoxyfen, pyribenzoxim, pyributicarb, pyriclor, pyridafol, pyridate, pyriftalid, pyriminobac, pyrimisulfan, pyrithiobac, pyroxasulfone, pyroxsulam, quinclorac, quinmerac, quinoclamine, quinonamid, quizalofop, quizalofop-P, rhodethanil, rimsulfuron, saflufenacil, S-metolachlor, sebuthylazine, secbumeton, sethoxydim, siduron, simazine, simeton, simetryn, SMA, sodium arsenite, sodium azide, sodium chlorate, sulcotrione, sulfallate, sulfentrazone, sulfometuron, sulfosulfuron, sulfuric acid, sulglycapin, swep, TCA, tebutam, tebuthiuron, tefuryltrione, tembotrione, tepraloxydim, terbacil, terbucarb, terbuchlor, terbumeton, terbuthylazine, terbutryn, tetrafluoron, thenylchlor, thiazafluoron, thiazopyr, thidiazimin, thidiazuron, thiencarbazone-methyl, thifensulfuron, thiobencarb, tiocarbazil, tioclorim, topramezone, tralkoxydim, tri-allate, triasulfuron, triaziflam, tribenuron, tricamba, triclopyr, tridiphane, trictazine, trifloxysulfuron, trifluralin, triflusulfuron, trifop, trifopsime, trihydroxytriazine, trimeturon, tripropindan, tritac tritosulfuron, vemolate, xylachlor and mixtures thereof.

Safeners mean active ingredients applied with herbicides to protect crops against their injury. Some of the safeners that can be employed in the present disclosure include, but are not limited to: benoxacor, benthiocarb, brassinolide, cloquintocet (mexyl), cyometrinil, daimuron, dichlormid, dicyclonon, dimepiperate, disulfoton, fenchlorazole-ethyl, fenclorim, flurazole, fluxofenim, furilazole, isoxadifen-ethyl, mefenpyr-diethyl, MG 191, MON 4660, naphthalic anhydride (NA), oxabetrinil, R29148, N-phenylsulfonylbenzoic acid amides and mixtures thereof.

An insecticide is a pesticide used against insects in all developmental forms, and include ovicides and larvicides used against the eggs and larvae of insects. Insecticides are used in agriculture, medicine, industry and the household.

Examples of insecticides that can be employed in the present disclosure include, but are not limited to: 1,2-dichloropropane, abamectin, acephate, acetamiprid, acethion, acetoprole, acrinathrin, acrylonitrile, alanycarb, aldicarb, aldoxycarb, aldrin, allethrin, allosamidin, allyxycarb, alpha-cypermethrin, alpha-ecdysone, alpha-endosulfan, amidithion, aminocarb, amiton, amiton oxalate, amitraz, anabasine, athidathion, azadirachtin, azamethiphos, azinphos-ethyl, azinphos-methyl, azothoate, barium hexafluoro silicate, barthrin, bendiocarb, benfuracarb, bensultap, beta-cyfluthrin, beta-cypermethrin, bifenthrin, bioallethrin, biocthanomethrin, biopermethrin, bistrifluoron, borax, boric acid, bromfenvinfos, bromocyclen, bromo-DDT, bromophos, bromophos-ethyl, bufencarb, buprofezin, butacarb, butathiofos, butocarboxim, butonate, butoxycarboxim, cadusafos, calcium arsenate, calcium polysulfide, camphechlor, carbanolate, carbaryl, carbofuran, carbon disulfide, carbon tetrachloride, carbophenothion, carbosulfan, cartap, cartap hydrochloride, chlorantraniliprole, chlorbicyclen, chlordane, chlordecone, chlordimeform, chlordimeform hydrochloride, chlorethoxyfos, chlorfenapyr, chlorfenvinphos, chlorfluazuron, chlormephos, chloroform, chloropicrin, chlorphoxim, chlorprazophos, chlorpyrifos, chlorpyrifos-methyl, chlorthiophos, chiOmafenozide, cinerin I, cinerin II, cinerins, cismethrin, cloethocarb, closantel, clothianidin, copper acetoarsenite, copper arsenate, copper naphthenate, copper oleate, coumaphos, coumithoate, crotamiton, crotoxyphos, crufomate, cryolite, cyanofenphos, cyanophos, cyanthoate, cyantraniliprole, cyclethrin, cycloprothrin, cyfluthrin, cyhalothrin, cypermethrin, cyphenothrin, cyromazine, cythioate, DDT, decarbofuran, deltamethrin, demephion, demephion-O, demephion-S, demeton, demeton-methyl, demeton-O, demeton-O-methyl, demeton-S, demeton-S-methyl, demeton-S-methylsulphon, diafenthiuron, dialifos, diatomaceous carth, diazinon, dicapthon, dichlofenthion, dichlorvos, dicresyl, dicrotophos, dicyclanil, dieldrin, diflubenzuron, dilor, dimefluthrin, dimefox, dimetan, dimethoate, dimethrin, dimethylvinphos, dimetilan, dinex, dinex-diclexine, dinoprop, dinosam, dinotefuran, diofenolan, dioxabenzofos, dioxacarb, dioxathion, disulfoton, dithicrofos, d-limonene, DNOC, DNOC-ammonium, DNOC-potassium, DNOC-sodium, doramectin, ecdysterone, emamectin, emamectin benzoate, EMPC, empenfhrin, endosulfan, endothion, endrin, EPN, epofenonane, eprinomectin, esdepallethrine, esfenvalerate, etaphos, ethiofencarb, ethion, ethiprole, ethoate-methyl, ethoprophos, ethyl formate, ethyl-DDD, ethylene dibromide, ethylene dichloride, ethylene oxide, etofenprox, etrimfos, EXD, famphur, fenamiphos, fenazaflor, fenchlorphos, fenethacarb, fenfluthrin, fenitrothion, fenobucarb, fenoxacrim, fenoxycarb, fenpirithrin, fenpropathrin, fensulfothion, fenthion, fenthion-ethyl, fenvalerate, fipronil, flonicamid, flubendiamide, flucofuron, flucycloxuron, flucythrinate, flufenerim, flufenoxuron, flufenprox, fluvalinate, fonofos, formetanate, formetanate hydrochloride, formothion, fomiparanate, fomiparanate hydrochloride, fosmethilan, fospirate, fosthictan, fufenozide, furathiocarb, furethrin, gamma-cyhalothrin, gamma-HCH, halfenprox, halofenozide, HCH, HEOD, heptachlor, heptenophos, heterophos, hexaflumuron, HHDN, hydramethylnon, hydrogen cyanide, hydroprene, hyquincarb, imidacloprid, imiprothrin, indoxacarb, iodomethane, IPSP, isazofos, isobenzan, isocarbophos, isodrin, isofenphos, isofenphosmethyl, isoprocarb, isoprothiolane, isothioate, isoxathion, ivermectin, jasmolin I, jasmolin II, jodfenphos, juvenile hormone I, juvenile hormone II, juvenile hormone III, kelevan, kinoprene, lambda-cyhalothrin, lead arsenate, lepimectin, leptophos, lindane, lirimfos, lufenuron, lythidathion, malathion, malonoben, mazidox, mecarbam, mecarphon, menazon, meperfluthrin, mephosfolan, mercurous chloride, mesulfenfos, metaflumizone, methacrifos, methamidophos, methidathion, methiocarb, methocrotophos, methomyl, methoprene, methothrin, methoxychlor, methoxyfenozide, methyl bromide, methyl isothiocyanate, methylchloroform, methylene chloride, metofluthrin, metolcarb, metoxadiazone, mevinphos, mexacarbate, milbemectin, milbemycin oxime, mipafox, mirex, molosultap, mo no crotopho s, monomehypo, mono sultap, morphothion, moxidectin, naftalofos, naled, naphthalene, nicotine, nifluridide, nitenpyram, nithiazine, nitrilacarb, novaluron, noviflumuron, omethoate, oxamyl, oxydemeton-methyl, oxydeprofos, oxydisulfoton, para-dichlorobenzene, parathion, parathion-methyl, penfluoron, pentachlorophenol, permethrin, phenkapton, phenothrin, phenthoate, phorate, phosalone, phosfolan, phosmet, phosnichlor, phosphamidon, phosphine, phoxim, phoxim-methyl, pirimetaphos, pirimicarb, pirimiphos-ethyl, pirimiphos-methyl, potassium arsenite, potassium thiocyanate, pp′-DDT, prallethrin, precocene I, precocene II, precocene III, primidophos, profenofos, profluralin, profluthrin, promacyl, promecarb, propaphos, propetamphos, propoxur, prothidathion, prothiofos, prothoate, protrifenbute, pymetrozine, pyraclofos, pyrafluprole, pyrazophos, pyresmethrin, pyrethrin I, pyrethrin II, pyrethrins, pyridaben, pyridalyl, pyridaphenthion, pyrifluquinazon, pyrimidifen, pyrimitate, pyriprole, pyriproxyfen, quassia, quinalphos, quinalphos-methyl, quinothion, rafoxanide, resmethrin, rotenone, ryania, sabadilla, schradan, selamectin, silafluofen, silica gel, sodium arsenite, sodium fluoride, sodium hexafluorosilicate, sodium thiocyanate, sophamide, spinetoram, spinosad, spiromesifen, spirotetramat, sulcofuron, sulcofuron-sodium, sulfluramid, sulfotep, sulfoxaflor, sulfuryl fluoride, sulprofos, tau-fluvalinate, tazimcarb, TDE, tebufenozide, tebufenpyrad, tebupirimfos, teflubenzuron, tefluthrin, temephos, TEPP, terallethrin, terbufos, tetrachloroethane, tetrachlorvinphos, tetramethrin, tetramethylfluthrin, theta-cypei-methiin, thiacloprid, thiamethoxam, thicrofos, thiocarboxime, thiocyclam, thiocyclam oxalate, thiodicarb, thiofanox, thiometon, thiosultap, thiosultap-disodium, thiosultap-monosodium, thuringiensin, tolfenpyrad, tralomethrin, transfluthrin, transpermethrin, triarathene, triazamate, triazophos, trichlorfon, trichlormetaphos-3, trichloronat, trifenofos, triflumuron, trimethacarb, triprene, vamidothion, vaniliprole, XMC, xylylcarb, zeta-cypermethrin, zolaprofos and mixtures thereof.

Miticides are pesticides that kill mites. Antibiotic miticides, carbamate miticides, formamidine miticides, mite growth regulators, organochlorine, permethrin and organophosphate miticides all belong to this category.

Molluscicides are pesticides used to control mollusks, such as moths, slugs and snails. These substances include metaldehyde, methiocarb and aluminium sulphate.

A nematicide is a type of chemical pesticide used to kill parasitic nematodes (a phylum of worm).

Preferably, the amount of pesticide(s) in the composition ranges from 1 to 95% by weight, relative to the total weight of the composition.

Preferably, the amount of antimicrobial(s) in the composition ranges from 1 to 95% by weight, relative to the total weight of the composition.

Preferably, the sum of the amount of antimicrobial(s) and of the amount of pesticide(s) in the composition ranges from 1 to 95% by weight, relative to the total weight of the composition

The composition according to the invention may comprise at least one biopesticide.

According to the invention, the term “biopesticide” includes microorganisms that control pests (microbial pesticides), macroorganisms that control pests, semiochemicals that control pests and natural substance of mineral, plant or animal origin that control pests.

Microbial pesticides means any microorganism, whether in a vegetative state, a dormant state (e.g., spore) or a whole broth culture, any substance derived from a microorganism (e.g., metabolites), or any fermentation product (e.g., supernatants, filtrates, extracts, etc.) that are pathogenic to a pest (e.g., capable of attacking, infecting, killing, disabling, causing disease, compete with and/or causing injury to a pest), and is thus able to be used in the control of a pest by adversely affecting the viability or growth of the target pest. Non-limiting examples of “microbial pesticides” include microbial nematocides, microbial insecticides, microbial fungicides, microbial bactericides, and microbial viricides).

Preferably, the biopesticide are chosen from fungal spores and/or bacterial spores.

Examples of fungal spores or conidia that are insecticidal or nematicidal or fungicidal include but not limited to the following classes: Basidiomycetes, Chytridiomycetes, Deuteromycetes, Hyphochytridiomycetes, Oomycetes, Plasmodiophoromycetes, Sordahomycetes, Thehomycetes and Zygomycetes, specifically the following fungi; Arthrobotrys superba, Arthrobotrys irregular, Beauveria bassiana, Erynia neoaphidis, Fusarium spp., Hirsute/Ia rhossiliensis, Hirsutella thompsonii, Lagenidium giganteum, Metarhiziurn anisopliae, Myrothecium, Neozygietes fresenii (Nowakowski), Nomuraca rileyi, Paccilomyces lilacinus, Pseudomonas chloroaphis, Pseudomonas spp., Psedozyma Flocculosa, Trichoderma harzianum, and Vericillium lecanii., Verticillium lecanii, plus those endoparasitic fungi described in the book of “Nematology Advances and Perspectives, Vol. 2 (2004)”, which is incorporated herein by reference in its relevant portion. Also included is a fungus genus “Esteya vermicola as described in U.S. Pat. No. 6,168,947 (incorporated by reference), as well as the “Arkansas Fungus 18’ as described in U.S. Pat. No. 5,019,389 (incorporated herein by reference).

Examples of bacterial spores include but not limited to Bacillus agri, Bacillus aizawai, Bacillus albolactis, Bacillus amyloliquefaciens, Bacillus cereus, Bacillus circulans, Bacillus coagulans, Bacillus endoparasiticus, Bacillus endorhythmos, Bacillus firmus, Bacillus kurstaki, Bacillus lacticola, Bacillus lactimorbus, Bacillus lactis, Bacillus laterosporus, Bacillus lentimorbus, Bacillus licheniformis, Bacillus macerans, Bacillus megatchum, Bacillus medusa, Bacillus metiens, Bacillus natto, Bacillus nigricans, Bacillus popillae, Bacillus pumiliss, Bacillus pumilus, Bacillus siamensis, Bacillus sphaehcus, Bacillus spp., Bacillus subtilis, Bacillus thuringiensis, Bacillus uniflagellatus, plus those listed in the category of Bacillus Genus in the “Todar's Online Textbook of Bacteriology, (2009)” which is incorporated herein by reference in its relevant portion. Also included are Photorhabdus luminescens, Xenorhabdus nematophilus, Pantoea agglomerans, and those nematicidal bacterial antagonists listed in “Nematology Advances and Perspectives, Vol. 2 (2004)”.

Preferably, the amount of biopesticide(s) in the composition ranges from 1 to 95% by weight, relative to the total weight of the composition.

The composition according to the invention may comprise at least one nutrient.

Nutrients refer to chemical elements and compounds which are desired or necessary to promote or improve plant growth. Nutrients generally are described as macronutrients or micronutrients.

Suitable nutrients for use in the compositions according to the invention may be micronutrient compounds, preferably those which are solid at room temperature (25° C.) or are partially soluble.

Micronutrients typically refer to trace metals or trace elements, and are often applied in lower doses. Suitable micronutrients include trace elements selected from zinc, boron, chlorine, copper, iron, molybdenum, and manganese.

The micronutrients may be in a soluble form or included as insoluble solids, and may in the form of salts or chelates. Preferably, the micronutrient is in the form of a carbonate or oxide.

Preferably, the micronutrients may be selected from zinc, calcium, molybdenum or manganese, or magnesium. More preferentially micronutrients for use in the compositions according to the invention may be selected from zinc oxide, manganese carbonate, manganese oxide, or calcium carbonate.

The composition according to the present invention may also comprise at least one macronutrient.

Macronutrients typically refer to those comprising nitrogen, phosphorus, and potassium, and include fertilisers such as ammonium sulphate, and water conditioning agents. Suitable macronutrients include fertilisers and other nitrogen, phosphorus, or sulphur containing compounds, and water conditioning agents.

Suitable fertilisers include inorganic fertilisers that provide nutrients such as nitrogen, phosphorus, potassium or sulphur. Examples of such fertilisers include:
for nitrogen as the nutrient: nitrates and or ammonium salts such as ammonium nitrate, including in combination with urea e.g. as uran type materials, calcium ammonium nitrate, ammonium sulphate nitrate, ammonium phosphates, particularly mono-ammonium phosphate, di-ammonium phosphate and ammonium polyphosphate, ammonium sulphate, and the less commonly used calcium nitrate, sodium nitrate, potassium nitrate and ammonium chloride;
for phosphorus as the nutrient: acidic forms of phosphorus such as phosphoric, pyrophosphoric or polyphosphoric acids, but more usually salt forms such as ammonium phosphates, particularly mono-ammonium phosphate, di-ammonium phosphate, and ammonium polyphosphate, potassium phosphates, particularly potassium dihydrogen phosphate and potassium polyphosphate;
for sulphur as the nutrient: ammonium sulphate and potassium sulphate, e.g. the mixed sulphate with magnesium.

Preferably, the amount of nutrient(s) in the composition range from 1 to 40% by weight, more preferentially from 10 to 35% by weight; even more preferentially from 15 to 30% by weight, relative to the total weight of the composition.

Preferably, the amount of micronutrient(s) in the composition range from 1 to 40% by weight, more preferentially from 10 to 35% by weight; even more preferentially from 15 to 30% by weight, relative to the total weight of the composition.

Preferably, the amount of macronutrient(s) in the composition range from 1 to 40% by weight, more preferentially from 10 to 35% by weight; even more preferentially from 15 to 30% by weight, relative to the total weight of the composition.

The term “biostimulant” is intended to mean a compound which may enhance metabolic or physiological processes such as respiration, photosynthesis, nucleic acid uptake, ion uptake, nutrient delivery, or a combination thereof.

Non-limiting examples of biostimulants include seaweed extracts (e.g., ascophyllum nodosum), humic acids (e.g., potassium humate), fulvic acids, myoinositol, glycine, and combinations thereof.

Preferably, the amount of biostimulant(s) in the composition range from 0.001 to 10% by weight, more preferentially from 0.01 to 5% by weight; even more preferentially from 0.1 to 1% by weight, relative to the total weight of the composition.

The composition according to the invention may comprise at least one plant growth regulator.

Plant growth regulators mean active ingredients used to influence the growth characteristics of plants. Examples of plant growth regulators which may be used in the present disclosure include, but are not limited to: 1-naphthaleneacetic acid, 1-naphthaleneacetic acid-salt, 1-napthol, 2,4-dichlorophenoxyacetic acid (2,4-D), 2,4-DB, 2,4-DEP, 2,3,5-triiodobenzoic acid, 2,4,5-trichlorophenoxyacetic acid, 2-naphthoxyacetic acid, 2-naphthoxyacetic acid sodium salt, 3-chloro-4-hydroxyphenylacetic acid, 3-indoleacetic acid, 4-biphenylacetic acid, 4-chlorophenoxyacetic acid (4-CPA), 4-hydroxyphenylacetic acid, 6-benzylaminopurine, auxindole, a-naphthaleneacetic acid K-salt, β-naphfhoxyacetic acid, p-chlorophenoxyacetic acid, dicamba, dichlorprop, fenoprop, indole-3-acetic acid (IAA), indole-3-acetyl-DL-aspartic acid, indole-3-acetyl-DL-tryptophan, indole-3-acetyl-L-alanine, indole-3-acetyl-L-valine, indole-3-butyric acid (IBA), indole-3-butyric acid K-salt, indole-3-propionic acid; a-naphthaleneacetic acid, methyl indole-3-acetate, naphthaleneacetamide, naphthaleneacetic acid (NAA), phenylacetic acid, picloram, potassium naphthenate, sodium naphthenate, 4-hydroxyphenethyl alcohol, 4-CPPU, 6-benzylaminopurine (BA), 6-(Y,Y-dimethylallylamino)purine (2iP), 2-iP-2HC1, adenine, adenine hemisulfate, benzyladenine, kinetin, meta-topolin, N6-benzoyladenine, N-benzyl-9-(2-tetrahydropyranyl) adenine (BP A), N-(2-chloro-4-pyridyl)-N-phenylurea, gibberellic acid (GA3), gibberellins, gibberellins A4+A7 (GA n), ethylene and abscisic acid.

Preferably, the amount of plant growth regulator(s) in the composition ranges from 1 to 95% by weight, relative to the total weight of the composition.

Preferably, the agrochemical composition according to the invention is aqueous.

More preferentially, the water content of the composition ranges from 5% to 99% by weight, more preferentially from 20% to 98% by weight, even more preferentially from 25% to 97% by weight, relative to the total weight of the composition.

Preferably, the pH of the agrochemical composition ranges from 1 to 11; more preferentially from 3 to 9; and even better from 4 to 8.

The pH of the agrochemical compositions can be adjusted to the desired value by means of basifying agents or acidifying agents. Use may be made, among the basifying agents, of one or more alkaline agents, such as ammonia, sodium hydroxide or ethanolamine. Mention may be made, by way of examples, among the acidifying agents, of inorganic or organic acids, such as hydrochloric acid or orthophosphoric acid.

The agrochemical composition according to the invention may further contains additives different from the ingredients described previously, such as binders, diluents, absorbents, dispersants different from those described previously, carriers, disintegration agents, wetting agents, emulsifiers, antifoam agents, antifreeze agents, solvents, viscosity modifiers, preservatives and/or anti-microbials.

Mention may be made for instance of (C₁-C₈) monoalcohols, (C₂-C₈) polyols, and mixtures thereof; such as ethanol, isopropanol, ethylene glycol, propylene glycol, and mixtures thereof.

Each additive can be present in the agrochemical composition according to the invention in an amount ranging from 0% to 20% by weight, more preferably from 0% to 10% by weight, relative to the total weight of the composition.

A person skilled in the art will be able to choose these optional additives and their amounts so that they do not harm the properties of the agrochemical compositions of the present invention.

Preferably, the viscosity of an aqueous agrochemical composition according to the invention, measured at 20 rpm using a Brookfield RV viscometer at 25° C. and at atmospheric pressure (1.013×10⁵ Pa), ranges from 500 mPa·s to 1 500 mPa·s; more preferentially from 700 to 1 300 mPa·s.

According to a preferred embodiment of the invention, the agrochemical composition comprises:
(i) at least one copolymer obtainable by radical polymerization of:
   at least the following monomers:
      a) acrylic acid,
      b) at least one β-carboxyethyl (meth)acrylate monomer,
      c) at least one alkyl (meth)acrylate monomer, said alkyl radical comprising from 1 to 12 carbon atoms,
      d) at least one hydrophobic non-acrylic monomer, and
      e) at least one (C₁-C₁₂)alkyloxy polyethylene glycol (meth)acrylate monomer,
      f) optionally methacrylic acid,
   in the presence of a free-radical polymerization initiator; and
(ii) at least one agricultural material;
wherein said copolymer (i) comprises from:
   0.1 to 15 mol. % of units from acrylic acid a),
   1 to 35 mol. % of units from β-carboxyethyl (meth)acrylate b),
   5 to 40 mol. % of units from alkyl (meth)acrylate c),
   30 to 60 mol. % of units from hydrophobic non-acrylic monomer d),
   1 to 30 mol. % of units from (C₁-C₁₂)alkyloxy polyethylene glycol (meth)acrylate e), and
   optionally from 0.1 to 20 mol. %, for instance from 0.1 to 5 mol %, for instance less than 2 mol %, for instance less than 1 mol %, of units from methacrylic acid f).

In said embodiment, the composition is preferably aqueous.

According to another preferred embodiment of the invention, the agrochemical composition comprises:
(i) at least one copolymer obtainable by radical polymerization of:
   at least the following monomers:
      a) acrylic acid,
      b) at least one β-carboxyethyl (meth)acrylate monomer,
      c) at least one alkyl (meth)acrylate monomer, said alkyl radical comprising from 1 to 12 carbon atoms,
      d) at least one hydrophobic non-acrylic monomer, and
      e) at least one (C₁-C₁₂)alkyloxy polyethylene glycol (meth)acrylate monomer,
      f) optionally methacrylic acid,
   in the presence of a free-radical polymerization initiator; and
(ii) at least one agricultural material;
wherein said copolymer (i) comprises from:
   0.5 to 10 mol. % of units from acrylic acid a),
   5 to 30 mol. % of units from β-carboxyethyl (meth)acrylate b),
   10 to 30 mol. % of units from alkyl (meth)acrylate c),
   35 to 50 mol. % of units from hydrophobic non-acrylic monomer d),
   5 to 25 mol. % of units from (C₁-C₁₂)alkyloxy polyethylene glycol (meth)acrylate e), and
   optionally from 5 to 20 mol. % of units from methacrylic acid f), or alternatively optionally from 0.1 to 5 mol %, for instance less than 2 mol %, for instance less than 1 mol %, of units from methacrylic acid f).

In said embodiment, the composition is preferably aqueous.

According to a more preferentially embodiment of the invention, the agrochemical composition comprises:
(i) at least one copolymer obtainable by radical polymerization of:
   at least the following monomers:
      a) acrylic acid,
      b) at least one β-carboxyethyl (meth)acrylate monomer of formula (I) as described above,
      c) at least one (C₆-C₈)alkyl acrylate monomer,
      d) at least one vinyl aromatic monomer, preferably styrene, and
      e) at least one (C₁-C₄)alkyloxy polyethylene glycol (meth)acrylate monomer,
      f) optionally methacrylic acid,
   in the presence of a free-radical polymerization initiator; and
(ii) at least one agricultural material;
wherein said copolymer (i) comprises from:
   0.1 to 15 mol. % of units from acrylic acid a),
   1 to 35 mol. % of units from β-carboxyethyl (meth)acrylate b) of formula (I),
   5 to 40 mol. % of units from (C₆-C₈)alkyl acrylate c),
30 to 60 mol. % of units from vinyl aromatic monomer d),
1 to 30 mol. % of units from (C₁-C₄)alkyloxy polyethylene glycol (meth)acrylate e), and
optionally from 0.1 to 20 mol. %, for instance from 0.1 to 5 mol %, for instance less than 2 mol %, for instance less than 1 mol %, of units from methacrylic acid f).

In said embodiment, the composition is preferably aqueous.

According to an even more preferentially embodiment of the invention, the agrochemical composition comprises:
(i) at least one copolymer obtainable by controlled radical polymerization of:
   at least the following monomers:
      a) acrylic acid,
      b) at least one β-carboxyethyl (meth)acrylate monomer of formula (I) as described above,
      c) at least one (C₆-C₈)alkyl acrylate monomer,
      d) at least one vinyl aromatic monomer, preferably styrene, and
      e) at least one methoxy polyethylene glycol (meth)acrylate monomer,
      f) optionally methacrylic acid, with
   a radical polymerization control agent, and
   a free-radical polymerization initiator; and
(ii) at least one agricultural material;
wherein said copolymer (i) comprises from:
   0.1 to 15 mol. % of units from acrylic acid a),
   1 to 35 mol. % of units from β-carboxyethyl (meth)acrylate b) of formula (I),
   5 to 40 mol. % of units from (C₆-C₈)alkyl acrylate c),
   30 to 60 mol. % of units from vinyl aromatic monomer d),
   1 to 30 mol. % of units from methoxy polyethylene glycol (meth)acrylate e), and
   optionally from 0.1 to 20 mol. %, for instance from 0.1 to 5 mol %, for instance less than 2 mol %, for instance less than 1 mol %, of units from methacrylic acid f).

In said embodiment, the composition is preferably aqueous.

According to another even more preferentially embodiment of the invention, the agrochemical composition is aqueous and comprises:
(i) at least one copolymer obtainable by controlled radical polymerization of:
   at least the following monomers:
      a) acrylic acid,
      b) at least one β-carboxyethyl (meth)acrylate monomer of formula (I) as described above,
      c) at least one (C₆-C₈)alkyl acrylate monomer,
      d) at least one vinyl aromatic monomer, preferably styrene, and
      e) at least one methoxy polyethylene glycol (meth)acrylate monomer,
      f) optionally methacrylic acid, with
   a radical polymerization control agent, and
   a free-radical polymerization initiator; and
(ii) at least one agricultural material;
wherein said copolymer (i) comprises from:
   0.1 to 15 mol. % of units from acrylic acid a),
   1 to 35 mol. % of units from β-carboxyethyl (meth)acrylate b) of formula (I),
   5 to 40 mol. % of units from (C₆-C₈)alkyl acrylate c),
   30 to 60 mol. % of units from vinyl aromatic monomer d),
   1 to 30 mol. % of units from methoxy polyethylene glycol (meth)acrylate e), and
   optionally from 0.1 to 20 mol. %, for instance from 0.1 to 5 mol %, for instance less than 2 mol %, for instance less than 1 mol %, of units from methacrylic acid f).

The agrochemical composition according to the invention may be in the form of a concentrate of agricultural material(s), a diluted concentrate, or a sprayable diluted. In particular, the agrochemical composition according to the invention may be in the form of an emulsifiable concentrate (EC), emulsion in water concentrate (EW), suspension concentrate (SC), flowable concentrate for seed treatment (FS), water dispersible granules (WDG) and/or suspoemulsions (SE).

More preferentially, the agrochemical composition according to the invention is formulated as a suspension concentrate (SC), a flowable concentrate for seed treatment (FS) or a suspoemulsions (SE).

According to a preferred embodiment of the invention, the agrochemical composition is an aqueous suspension having a concentration of greater than 0.05 g/L of agricultural material(s).

More preferentially according to this embodiment, the agrochemical composition is an aqueous suspension having a concentration of between 0.05 g/L to 1 200 g/L of agricultural material(s).

According to another preferred embodiment of the invention, the agrochemical composition is a concentrated aqueous suspension having a concentration of greater than 50 g/L of agricultural material(s).

More preferentially according to this embodiment, the agrochemical composition is a concentrated aqueous suspension having a concentration of between 50 g/L to 1 200 g/L of agricultural material(s), even more preferentially between 400 g/L to 1 200 g/L, for instance higher than 700 g/L.

According to another preferred embodiment of the invention, the concentrated agrochemical composition may be diluted in water for use resulting in a dilute composition having a concentration of greater than 0.05 g/L of agricultural material(s).

More preferentially according to this embodiment, the concentrated agrochemical composition may be diluted in water for use resulting in a dilute composition having a concentration of between 0.05 g/L to 120 g/L of agricultural material(s), even more preferentially between 0.4 g/L to 120 g/L, for instance higher than 0.7 g/L.

According to a particular embodiment of the invention, the agrochemical composition according to the invention is formulated as water dispersible granules (WDG).

The granules can include solid support, filler or diluent material(s) which is desirably inert to the agricultural material(s), but which is readily dispersible in water, if necessary in conjunction with dispersing agents. These materials may also have the benefit of reducing granule dry clumping and the disintegration rate (on addition to water) and can also be used to adjust the agricultural material(s) concentration(s).

Examples include clays such as kaolin (china clay) and bentonite clays, which may be natural bentonites or modified e.g. activated bentonites, synthetic and diatomaceous silicas, calcium and magnesium silicates, titanium dioxide, aluminium, calcium or magnesium carbonate, ammonium, sodium, potassium, calcium or barium sulphate, charcoal, starch, including modified starches such as alkyl and carboxyalkyl starches, cellulose, such as microcrystalline cellulose, and cellulose derivatives such as carboxyalkyl cellulose, and mixtures of two or more such solid support, filler, diluent materials.

The copolymer according to the invention facilitates the disintegration of the granules after the addition of water to form a homogeneous dispersion and guarantee good performances at dilution including a good suspensibility of the active ingredients, and lead to low residues, when passing the diluted formulation through a sieve of mesh size of 200. The suspensibility performances can be evaluated with the CIPAC method MT184 after a dilution at 0.5% in CIPAC standard waters A, D or C. The easiness of disintegration of the granules to form a dispersion is evaluated after a dilution at 1% in CIPAC standard water D in a measuring cylinder. The number of inversions of the measuring cylinder to disintegrate completely the granules and to form a suspension is assessed, with an acceptance criteria to be below than 30 inversions. Furthermore, the copolymer according to the invention significantly reduces the amount of non-dispersible material obtained after dilution of the WDG formulation. The amount of non-dispersible material can be evaluated with the CIPAC method MT185 (wet sieve test). A sample of the formulation is dispersed in water and the suspension formed is transferred to a sieve, for example of 200 mesh size, and washed. The amount of the material retained on the sieve is determined by drying and weighing.

Furthermore, the copolymer according to the invention may reduce the pressure during the possible granulation of the agrochemical composition compared to the pressure during granulation of the same agrochemical composition without addition of the copolymer according to the invention.

Granulation is a process used for preparing water dispersible granules formulations. In the process of granulation, after milling the agricultural material(s) with solid additives, some amount of water (up to 30% w/w) is added. The copolymer according to the invention is added together with this water. Then the powder is introduced to the granulator. The granulator, made of wings rotating at a certain speed (which is determined by the user), pushes the powder through a screen with small holes. In hard cases the powder creates a large pressure that resists this transfer through the screen.

The copolymer layer formed on the particles using the copolymer according to the invention may improve granulation by remarkably reducing the pressure that develops during the granulation process.

The copolymer according to the invention may also reduce the viscosity of the agrochemical composition during milling of the composition compared to the viscosity of the same agrochemical composition during milling without addition of the copolymer according to the invention.

In addition, the copolymer according to the invention may also reduce the temperature during milling of the agrochemical composition compared to the temperature during milling of the same agrochemical composition during milling without addition of the copolymer according to the invention.

Wet milling is a process used for preparing suspension concentrate formulations. The copolymer layer formed on the particles by the copolymer according to the invention may lower/reduce interactions between the particles thereby, reducing viscosity and allowing the suspension to be loaded with a high concentration of particles without increasing the temperature of the system.

Accordingly, the present copolymer according to the invention permits greater density of the formulations and an efficient, low temperature wet milling process.

In addition, the invention relates to the use of the agrochemical composition as described previously, for the treatment of soils, plants and/or seeds to control pests and/or to regulate the growth of plants.

The invention also relates to a method for treating soils, plants and/or seeds to control pests and/or to regulate the growth of plants, by applying the composition according to the invention as described previously to at least one plant, area adjacent to a plant, soil adapted to support growth of a plant, root of a plant, foliage of a plant, and/or seed adapted to produce a plant.

The application of the composition according to the invention may kill or inhibit pests and/or clean and/or inhibit growth of undesired plants.

The agrochemical composition according to the invention can be diluted and applied to at least one plant, area adjacent to a plant, soil adapted to support growth of a plant, root of a plant, foliage of a plant, and/or seed adapted to produce a plant, in a customary manner; for example by watering (drenching), drip irrigation, spraying, and/or atomizing.

In the above description, all the preferred embodiments with regard to the components may be used individually or in combination.

The examples that follow serve to illustrate the invention.

### EXAMPLES

### General Synthesis Procedure:

The comparative copolymers A and I and the copolymers B and D according to the invention were synthetized according to the same process.

The applied process in case of the examples A, B, D and I is based on the controlled radical polymerization technology in the presence of the RAFT (Madix) type transfer agent. The applied transfer agent chemistry is the xanthate and the grade used is the Rhodixan A1. The calculation of the quantity of the transfer agent to be used for polymerization is based on the target average number molar mass of the copolymer (equation below)

$$masse ( grams ) Transfer agent = \frac{\sum masse ( grams ) of all monomers * Mw of the transfer agent}{Mn target of the polymer}$$

The target average number molecular mass of the copolymers A, B, D and I is Mn=5000 g/mol.

The whole synthesis is conducted in typical polymerization reactor under nitrogen atmosphere at given temperature and with efficient mechanical agitation system. The polymerization solvent is the mixture of the ethanol and water. In the cases of the copolymer D, the methoxypolyethylene glycol (MPEG 750) is also used as a co-solvent.

In a first time (polymerization step), the purged with nitrogen reactor is charged with all monomers, transfer agent and solvents and the reaction medium is heated to 75° C. under stirring. A part (20 wt. % of the overall amount) of the AMBN initiator ((2,2′-Azobis(2-methylbutyronitrile)) solution (20 wt. % in ethanol) is added in one shot to the reaction mixture. The reaction is allowed to react for around 30 min. After this time, the rest of AMBN solution in ethanol is added over the course of around 3 hours by pump. Once the addition is completed, the reaction mixture is let to react for further 10 hours.

In a second time (ethanol removal step), the ethanol is evaporated using a rotatory evaporator, and then water is added to the mixture; the mass of water is the same as the quantity of the ethanol used initially for reaction.

In a third time (neutralization and transfer agent deactivation step) the copolymer solution in water is placed into the reactor, the pH is adjusted to about 7.5 to 8 with sodium hydroxide and heated at 70° C. under stirring. The hydrogen peroxide solution (30 wt. % in water) is added by pump over 1 hour. The reaction is let to react for around 3 hours. A sample is collected for analyses to determine residual monomers, transfer agent and ethanol. A dry extract is measured by gravimetric method. The copolymer solution in water is also tested on pH and viscosity.

According to this procedure several copolymers were synthetized, with different monomer molar ratios and copolymer molar masses.

The particular reagents and their amounts are given in the table below.

| | Quantities used in grams | | | |
|---|---|---|---|---|
| | Copolymer | Copolymer | Copolymer | Copolymer |
| Raw material | A (Comp.) | B (Inv.) | D (Inv.) | I (Comp.) |
| Ethanol | 321.12 | 337.53 | 268.96 | 1137.5 |
| (solvent) | | | | |
| Water | 228.88 | 212.47 | 220.21 | 0.00 |
| (solvent) | | | | |
| 2-Ethyl Hexyl | 74.87 | 69.50 | 72.03 | 0.00 |
| Acrylate | | | | |
| monomer | | | | |
| MPEGMA95 | 0.00 | 0.00 | 0.00 | 338.57 |
| 0 monomer | | | | |
| MPEGMA75 | 228.88 | 212.47 | 220.21 | 0.00 |
| 0 monomer | | | | |
| MPEG 750 | 0.00 | 0.00 | 60.82 | 0.00 |
| solvent | | | | |
| Styrene | 89.92 | 83.48 | 86.52 | 129.73 |
| monomer | | | | |
| Methacrylic | 0.00 | 0.00 | 23.07 | 0.00 |
| Acid | | | | |
| monomer | | | | |
| Acrylic Acid | 32.96 | 0.00 | 0.00 | 0.00 |
| monomer | | | | |
| Sipomer ® | 0.00 | 61.19 | 24.80 | 111.19 |
| BCEA | | | | |
| monomers | | | | |
| (mixture of | | | | |
| acrylic acid | | | | |
| monomer and | | | | |
| β- | | | | |
| carboxyethyl | | | | |
| (meth)acrylate | | | | |
| monomers of | | | | |
| formula (I) | | | | |
| according to | | | | |
| the invention) | | | | |
| Rhodixan A1 | 17.07 | 17.07 | 17.07 | 24.11 |
| transfer agent | | | | |
| AMBN | 6.30 | 6.30 | 6.30 | 8.90 |
| initiator | | | | |
| Sodium | 43.18 | 40.56 | 41.80 | 62.8 |
| hydroxide | | | | |
| (50% in water) | | | | |
| Hydrogen | 29.07 | 29.02 | 29.44 | 40.00 |
| peroxide | | | | |
| (30% in water) | | | | |

The table below regroups obtained copolymers characteristics.

| | | | Copolymer | | | |
|---|---|---|---|---|---|---|
| Properties | Method | Unit | A | B | D | I |
| pH | pH | | 7.0 | 6.3 | 6.8 | 6.6 |
| (at 25° C., | electrode | | | | | |
| solution as is) | | | | | | |
| Solid Content | Gravimetric | % wt. | 45.1 | 43.7 | 45.1 | 31.7 |
| (115° C.; | | | | | | |
| 30 min; 1 g) | | | | | | |
| Viscosity (at | Brookfield | mPa · s | 920 | 2250 | 190 | 200 |
| 25° C.) | | | | | | |
| Residual | HPLC / GC | % | <0.5 | <0.5 | <0.5 | <0.2 |
| monomers | | | | | | |
| (total) | | | | | | |

### Molar Mass Determination

In the present patent application, unless otherwise indicated, when reference is made to molar mass, it will relate to the absolute weight-average molar mass, expressed in g/mol.

Light scattering is an absolute technique, meaning that it does not depend on any calibration standards or calibration curves (M. W. Spears, The Column 12(11), 18-21 (2016)).

The fundamental light scattering equation is:

$$i ( θ ) ∝ M \times c \times {( \frac{dn}{d c} )}^{2} \times P ( θ )$$

where the intensity of scattered light at an angle θ is directly proportional to the product of the molar mass M, the concentration c, the square of the specific refractive index increment dn/dc, and an angular factor P(θ), which equals 1 at θ=0. The absolute intensity of scattered light extrapolated to θ=0 is used to calculate molecular weight, and the variance of this intensity with angle is used to calculate the root mean square (rms) radius of the sample.

The mass distribution of the polymer is measured by SEC MALS analysis (SEC: Size Exclusion Chromatography—MALS: Multi-Angle Laser Scattering) in order to obtain the real values, expressed in g/mol.

The SEC MALS analysis is performed with an HPLC chain equipped with 2 detectors:
Differential refractometer RI—the concentration detector
MALS detector (Multi-Angle Laser Scattering)—the mass detector.

The software records the chromatograms of the detectors:
One for the RI detector,
One for each angle of the MALS detector.

For each slice of the chromatograms (for the polymeric species), the software calculates:
The concentration of the polymer, RI signal=constant*dn/dc*concentration
The mass Mi of the slice,

$$M A L S detector = scattered light ∞ constant \times Mi \times {( dn / d c )}^{2} \times concentration$$

From particular Mi data, the software calculates the mass distribution: Mw, Mn and Polydispersity index PDI=Mw/Mn.

The calculation of the molar masses requires the refractive index increment, dn/dc of the polymer. It is a constant, depending on the nature of the mobile phase, the temperature of the experimental conditions and the wavelength of the laser among others.

This constant can be measured according to the eluted fraction from the SEC MALS analysis. This constant can be measured with a refractometer. This constant can be found also, for example, in the “Polymer Handbook” or website like www.ampolymer.com/dn-dc.html.

For these copolymers, “dn/dc” is calculated by the software according the mass recovery of the eluted fraction: the dn/dc=0.09 leads from 95 to 100% wt mass recovery.

For these copolymers, the molar mass were calculated based on the real Mi points, without any adjustment of the log(M) curve.

The applied injection amount and Standard sample concentration were as follows: 100 μL, from 2.0 to 2.4 mg/mL (calculated as dry polymer).

Detailed Analysis conditions:
Analysis instrument: Agilent SEC system with MALS detector
Pump: Agilent 1100
Detector: Agilent 1100, Differential Refractometer (RI)
Mobile phase: 100% THF, 0.01 mol/L tetrabutylammonium tetrafluoroborate, 100 μL TFA/1L THF (TFA: trifluoroacetic acid)
Column: Agilent Polypore (2*30 cm)+guard column
Temperature: 35° C.
Flow rate: 1.0 mL/min
Injection amount and Sample concentration: 100 μL, from 2.0 to 2.4 mg/mL (expressed in dry)
Data processing: ASTRA 7 (Wyatt)

The measured for particular copolymers molar masses were the following:

| | Copolymer Composition, % mol | | | | | | | | |
|---|---|---|---|---|---|---|---|---|---|
| | | | | | | MPEG | | | |
| | | | | | | MA 750 | Mw | | |
| Copolymer | AA | BCE | MA | St | 2EHA | (or 950) | (g/mol) | Mn | PDI |
| A | 22.5 | 0 | 0 | 42.5 | 20 | 15 | 13900 | 5800 | 2.4 |
| (Comp.) | | | | | | | | | |
| B | 9 | 13.5 | 0 | 42.5 | 20 | 15 | 14600 | 6700 | 2.2 |
| (Inv.) | | | | | | | | | |
| D | 3.5 | 5.3 | 13.7 | 42.5 | 20 | 15 | 15300 | 7650 | 2.0 |
| (Inv.) | | | | | | | | | |
| I | 13 | 19.5 | 0 | 52.5 | 0 | 15 | — | — | — |
| (Comp.) | | | | | | | | | |

With AA=acrylic acid; BCE=β-carboxyethyl (meth)acrylate monomers of formula (I) according to the invention; MA=methacrylic acid; St=styrene; 2EHA=2-ethyl hexyl acrylate; MPEGMA750 (or 950)=methoxy polyethylene glycol methacrylate.

In the example of formulations below, the comparative dispersant polymers F and G were also used.

The polymer F corresponds to the dispersant sold under the reference Geropon® Da 1349 by the company SOLVAY.

The polymer G corresponds to the dispersant sold under the reference Atlox™ 4915 by the company CRODA.

The polymer J corresponds to the dispersant sold under the reference Atlox™ 4917 by the company CRODA.

### Formulations:

### Formulation 1: Metazachlor SC Formulation

Metazachlor 400 g/L SC formulations with the copolymers A, B and F at 2 different dispersant dose rates were prepared and characterized to assess the dispersant performances. In Table 1 is detailed the composition of the SC formulations studied. In the table below, the amount of dispersant polymer is expressed in g/L of active material (i.e. of dispersant copolymer only).

TABLE 1
SC formulation for Metazachlor active ingredients

| Ingredient | g/L |
|---|---|
| Metazachlor (98.1% purity) | 408 |
| Antifreeze agent | 50 |
| Antifoaming agent | 2 |
| Wetting agent | 10 |
| (Rhodasurf 860/P from SOLVAY) | |
| Dispersant polymer | 6-19.8 in active |
| Rheological agent (2% solution) | 135 |
| (Rhodopol ® 23 from SOLVAY) | |
| Water | Up to 1 L |

Regarding the formulation procedure, an initial mixture is prepared in a glass beaker by adding the different constituents of the mixture in the following order of introduction: dispersant polymer, antifreeze agent, wetting agent, antifoaming agent, water, and the active ingredient. After each addition, the medium is homogenized by stirring with a glass rod and then finally with a high speed agitator (Ultra Turrax T50 basic IKA Werke, 2000 rpm) for 5 minutes. The mixture is then transferred to the Vibromac vertical wet miller containing 300 ml of grinding balls (oxide of zirconium, diameter 1 mm) and milled for 30 minutes. The mixture is then transferred in a glass beaker. The rheological agent in aqueous solution is then added, the medium is homogenized with a high speed agitator.

For each system, viscosity, particle size distributions, optical microscopy observations, suspensibility and dispersion characteristics were assessed initially and after storage at elevated temperature. The rotational viscosity was measured with a RV Brookfield apparatus, the viscosities were measured at 20° C., 20 rpm after 1 minute of rotation. Particle size distributions were measured by laser diffraction with a Malvern Mastersizer 2000 apparatus and compared using the parameter D50 corresponding to the particle diameter such as the cumulative undersized volume fraction of particles is equal to 50%. The suspensibility performances of the different dispersants were evaluated with the CIPAC method MT184 after dilution at 1% in CIPAC D standard water and carried out at 30° C. The dispersion test is an in-house test developed to quickly assess the performance of a dispersant system, it involves the preparation of 100 mL of diluted suspension at 2% by 10 inversions of the measuring cylinder. After 2 hours at rest in a thermostated bath at 30° C., the height of the sediment formed at the bottom of the graduated cylinder is assessed and expressed as a percentage, with an acceptance criteria to be below than 1%. The suspensibility and dispersion tests were performed with CIPAC D standard water.

In Table 2 are reported the dispersion performances, the suspensibility and the viscosity values of the SC formulations prepared with the different copolymers after 3 months of storage at 45° C. For the viscosity, the initial values are indicated in brackets.

TABLE 2
Dispersion performances of Metazachlor SC formulations with
copolymers A, B and F after 3 months of storage at 45° C.

| | Dispersant | | | |
|---|---|---|---|---|
| | active dose | | | |
| | rate in SC | | | Viscosity |
| Dispersant | formulation | Suspensibility | Dispersion | (mPa · s) − |
| polymer | (g/L) | (%) | (%) | (initial value) |
| A (Comp.) | 19.8 | 93 | 0.4 | 880 (870) |
| B (Inv.) | 19.8 | 92 | 0.5 | 760 (860) |
| F(Comp.) | 19.8 | 85 | 1.8 | 1100 (1030) |
| A(Comp.) | 6.0 | 88 | 0.7 | 1450 (990) |
| B (Inv.) | 6.0 | 91 | 0.4 | 850 (980) |
| F(Comp.) | 6.0 | 89 | 1.1 | 880 (970) |

At a dose rate of 19.8 g/L of active dispersant, the copolymers A and B offer comparable performances after storage in terms of suspensibility and dispersion with acceptable viscosities. In comparison, at this dose rate, the copolymer F offers lower suspensibility performances and poor dispersant performances. At the lower dose rate of dispersant investigated (6.0 g/L), the three copolymers present comparable performances in terms of suspensibility after storage. However, the comparative copolymer A presents a significant increase of viscosity after ageing (+460 mPa·s), reaching a viscosity value of 1450 mPa·s, which is not acceptable. For the comparative copolymer F poor dispersion performances are measured after ageing. In conclusion, the copolymer B according to the invention presents superior dispersant performances compared to the comparative copolymers A and F with superior dispersion performances and no viscosity increase after ageing even at low dose rate.

### Formulation 2: Folpet SC Formulation

Folpet 500 g/L SC formulations with the copolymers B and F at 2 different dispersant dose rates were prepared and characterized to assess the dispersant performances. In Table 3 is detailed the composition of the SC formulation studied. In the table below, the amount of dispersant polymer is expressed in g/L of active material (i.e. of dispersant copolymer only).

TABLE 3
SC formulation for Folpet active ingredients

| Ingredient | g/L |
|---|---|
| Folpet (98.9% purity) | 506 |
| Antifreeze agent | 50 |
| Antifoaming agent | 2 |
| Wetting agent | 5 |
| (Rhodasurf 860/P from SOLVAY) | |
| Dispersant polymer | 14.0-18.8 in active |
| Rheological agent (2% solution) | 130 |
| (Rheozan ® from SOLVAY) | |
| Water | Up to 1 L |

Regarding the formulation procedure, an initial mixture is prepared in a glass beaker by adding the different constituents of the mixture in the following order of introduction: dispersant polymer, antifreeze agent, wetting agent, antifoaming agent, water, and the active ingredient. After each addition, the medium is homogenized by stirring with a glass rod and then finally with a high speed agitator (Ultra Turrax T50 basic IKA Werke, 2000 rpm) for 5 minutes. The mixture is then transferred to the Vibromac vertical wet miller containing 300 ml of grinding balls (oxide of zirconium, diameter 1 mm) and milled for 30 minutes. The mixture is then transferred in a glass beaker. The rheological agent in aqueous solution is then added, the medium is homogenized with a high speed agitator.

For each system, viscosity, particle size distributions, optical microscopy observations, suspensibility and dispersion characteristics were assessed initially and after storage at elevated temperature. The rotational viscosity was measured with a RV Brookfield apparatus, the viscosities were measured at 20° C., 20 rpm after 1 minute of rotation. Particle size distributions were measured by laser diffraction with a Malvern Mastersizer 2000 apparatus and compared using the parameter D50 corresponding to the particle diameter such as the cumulative undersized volume fraction of particles is equal to 50%. The suspensibility performances of the different dispersants were evaluated with the CIPAC method MT184 after dilution at 1% in CIPAC D standard water and carried out at 30° C. The dispersion test is an in-house test developed to quickly assess the performance of a dispersant system, it involves the preparation of 100 mL of diluted suspension at 2% by 10 inversions of the measuring cylinder. After 2 hours at rest in a thermostated bath at 30° C., the height of the sediment formed at the bottom of the graduated cylinder is assessed and expressed as a percentage, with an acceptance criteria to be below than 1%. The suspensibility and dispersion tests were performed with CIPAC D standard water.

The characterization (suspensibility and dispersion) of the two SC formulations after 3 months of storage at 45° C. are reported in Table 4 for the two copolymer dose rates.

TABLE 4
Characterization of Folpet SC formulations
with copolymers B and F

| | Dispersant active | | |
|---|---|---|---|
| | dose rate in SC | | |
| Dispersant | formulation | Suspensibility | Dispersion |
| polymer | (g/L) | (%) | (%) |
| B (Inv.) | 14.0 | 92 | 0.8 |
| F (Comp.) | 14.0 | 89 | 1.3 |
| B (Inv.) | 18.8 | 93 | 0.5 |
| F (Comp.) | 18.8 | 92 | 1.3 |

Comparable suspensibility performances are measured for the two copolymers at the two dose rates after ageing. However, superior performances in terms of dispersion are obtained with the copolymer B according to the invention than with the comparative copolymer F. The SC formulation prepared with the copolymer F presents a dispersion value superior to 1.0 for the two copolymer dose rates, which is not acceptable. Hence, the copolymer B presents superior dispersant performances than the copolymer F.

Formulation 3: Combo formulation: Terbuthylazine SC+Glyphosate Potassium SL

Combo formulation Terbuthylazine SC+Glyphosate-K SL with the dispersant copolymers A, B, I, FG and J were prepared and characterized to assess the dispersant performances. In Table 5 is detailed the composition of the SC formulations studied.

TABLE 5
combo formulation Terbuthylazine 35%
w/w SC + Glyphosate potassium SL

| | SC Terbuthylazine |
|---|---|
| Ingredient | (% w/w) |
| Terbuthylazine (88% purity) | 39.8 |
| Antifreeze agent | 5.0 |
| Antifoaming agent | 0.3 |
| Wetting agent (Antarox L64 from | 0.5 |
| SOLVAY) | |
| Dispersant polymer | 3.0 |
| Rheological agent (2% solution) | 6.0 |
| (Rhodopol ® 23 from SOLVAY) | |
| Glyphosate-K SL solution (48% a.e.) | 0-20 |
| Water | up to 100% |

Regarding the formulation procedure, an initial mixture is prepared in a glass beaker by adding the different constituents of the mixture in the following order of introduction: dispersant polymer, antifreeze agent, wetting agent, antifoaming agent, water, and the active ingredient. After each addition, the medium is homogenized by stirring with a glass rod and then finally with a high speed agitator (Ultra Turrax T18 basic IKA Werke, 2000 rpm) for 5 minutes. The mixture is then transferred to the VIBRO-MAC Lab2 wet miller containing 200 g of grinding balls (Glass, diameter 1.3-1.6 mm) and milled for 30 minutes. The mixture is then transferred in a glass beaker. The glyphosate potassium salt SL were added post milling and before the addition of the rheological agent. The rheological agent in aqueous solution is then added, the medium is homogenized with a high speed agitator.

For each system, viscosity, particle size distributions, optical microscopy observations and suspensibility characteristics were assessed initially and after storage at elevated temperature. The rotational viscosity was measured with a RV Brookfield apparatus, the viscosities were measured at 20° C., 20 rpm after 1 minute of rotation. Particle size distributions were measured by laser diffraction with a Malvern Mastersizer 2000 apparatus and compared using the parameter D50 corresponding to the particle diameter such as the cumulative undersized volume fraction of particles is equal to 50%. The suspensibility performances of the different dispersants were evaluated with the CIPAC method MT184 after dilution at 1% in CIPAC D standard water and carried out at 30° C.

The viscosity after the addition of the Glyphosate potassium salt and before the addition of the rheological agent are reported in Table 6 for the different copolymers for the different Glyphosate potassium salt concentration.

The notation EEE corresponds to viscosity values superior to the viscosity limit for the selected measuring method (Brookfield RV, spindle 63, 20 rpm), i.e. a viscosity value superior to 5000 mPa·s.

TABLE 6
Initial viscosity (in mPa · s) of the combo formulation
Terbuthylazine SC + Glyphosate-K SL (before the addition
of the rheological agent) for the different copolymers

| Dispersant | GlyK SL concentration | | | | |
|---|---|---|---|---|---|
| copolymer | 0 | 5% | 10% | 15% | 20% |
| A (Comp.) | 132 | 114 | 502 | EEE | — |
| B (Inv.) | 6 | 48 | 48 | 900 | EEE |
| I (Comp.) | 72 | 114 | 228 | 2022 | EEE |
| F (Comp.) | 138 | 120 | 1392 | EEE | EEE |
| G (Comp.) | 48 | 72 | 107 | 126 | 582 |

For all the copolymers, an increase of the viscosity of the formulation is observed with the increase of the glyphosate potassium concentration. However, the increase is not to the same extent for the different copolymers. A large viscosity increase is measured for the copolymers A and F with a viscosity superior to 500 mPa·s with 10% of glyphosate potassium SL in the formulations and for the copolymer I with a viscosity superior to 2 000 mPa·s with 15% of glyphosate potassium SL in the formulations. In comparison, the copolymers B and G limit the viscosity increase.

In Table 7 are reported the suspensibility performances of the different copolymers initially and after 2 weeks of storage at 54° C. in the formulation with 10% w/w of Glyphosate potassium salt SL solution (Round Up Flash Plus, available from Bayer).

TABLE 7
Suspensibility performances of the combo formulation Terbuthylazine
SC + 10% w/w Glyphosate potassium salt SL solution
(Round Up Flash Plus, available from Bayer) initially and
after two weeks at 54° C. for the different copolymers

| Dispersant polymer | Initial | 2 weeks at 54° C. |
|---|---|---|
| A (Comp.) | >98% | >98% |
| B (Inv.) | >98% | >98% |
| I (Comp.) | >98% | >98% |
| F (Comp.) | 28% | 36% |
| G (Comp.) | 49% | 56% |
| J (Comp.) | 65% | 40% |

Excellent suspensibility performances are measured for the copolymers A, B and I, initially and after storage at 54° C. On the contrary, poor performances are observed for the copolymers F, G and J with low values of suspensibility or even the observation of a solidification. In conclusion, the copolymers B and I offer superior suspensibility performances than the copolymers F, G and J and a better control of the viscosity increase due to the addition of glyphosate potassium than the copolymer A. Hence, the copolymer B presents interesting performances for systems containing soluble active salts like glyphosate potassium.

For each system, viscosity were assessed initially and after storage at elevated temperature. The rotational viscosity was measured with a RV Brookfield apparatus, the viscosities were measured at 20° C., 20 rpm after 1 minute of rotation. The viscosity after the addition of the Glyphosate potassium salt SL solution and after the addition of the rheological agent are reported in Table 8 for the different copolymers for a Glyphosate potassium salt SL solution concentration of 10% w/w.

TABLE 8
Viscosity (in mPa · s) of the combo formulation Terbuthylazine
SC + with 10% w/w of Glyphosate potassium salt SL
solution (Round Up Flash Plus, available from Bayer) (after
the addition of the rheological agent) for the different
copolymers, initially and after 2 weeks at 54° C.

| | | Viscosity (after 2 |
|---|---|---|
| Dispersant copolymer | Viscosity (initial) | weeks at 54° C.) |
| B (Inv.) | 410 | 395 |
| F (Comp.) | 1,400 | 1,590 |
| J (Comp.) | Close to 5,000 | EEE |

The notation EEE corresponds to viscosity values superior to the viscosity limit for the selected measuring method (Brookfield RV, spindle 63, 20 rpm), i.e. a viscosity value superior to 5,000 mPa·s.

These data demonstrate that the copolymer B presents interesting performances for systems containing soluble active salts like glyphosate potassium.

1. An agrochemical composition comprising:
(i) at least one copolymer obtainable by radical polymerization of:
at least the following monomers:
a. acrylic acid,
b. at least one β-carboxyethyl (meth)acrylate monomer,
c. at least one alkyl (meth)acrylate monomer, said alkyl radical comprising from 1 to 12 carbon atoms,
d. at least one hydrophobic non-acrylic monomer, and
e. at least one (C₁-C₁₂)alkyloxy polyethylene glycol (meth)acrylate monomer,
in the presence of a free-radical polymerization initiator; and
(ii) at least one agricultural material.

2. The composition according to claim 1, wherein said copolymer (i) comprises from 0.1 to 15 mol. % of units from acrylic acid a.

3. The composition according to claim 1, wherein the β-carboxyethyl (meth)acrylate monomer(s) are of the following formula (I): 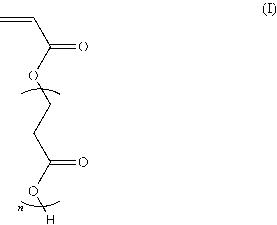
and wherein n is an integer ranging from 1 to 5.

4. The composition according to claim 1, wherein said copolymer (i) comprises from 1 to 35 mol. % of units from β-carboxyethyl (meth)acrylate b.

5. The composition according to claim 1, wherein the (C₁-C₁₂)alkyl (meth)acrylate monomer(s) are chosen from (C₁-C₁₂)alkyl acrylate.

6. The composition according to claim 1, wherein said copolymer (i) comprises from 5 to 40 mol. % of units from alkyl (meth)acrylate c).

7. The composition according to claim 1, wherein the hydrophobic non-acrylic monomer(s) are chosen from vinyl aromatic monomers.

8. The composition according to claim 1, wherein said copolymer (i) comprises from 30 to 60 mol. % of units from hydrophobic non-acrylic monomer d).

9. The composition according to claim 1, wherein said copolymer (i) comprises from 1 to 30 mol. % of units from (C₁-C₁₂)alkyloxy polyethylene glycol (meth)acrylate e).

10. The composition according to claim 1, wherein the monomers used of the polymerization of said copolymer (i) further include a methacrylic acid monomer f); and wherein said copolymer (i) comprises from 0.1 to 20 mol. % of units from methacrylic acid f).

11. The composition according to claim 1, wherein the polydispersity index of said copolymer (i) ranges from 1 to 3.5.

12. The composition according to claim 1, wherein said copolymer (i) is free of unit from strong acid derivatives of (meth)acrylic acid monomers.

13. The composition according to claim 1, wherein the said copolymer (i) has a weight average molecular weight (Mw) less than or equal to 20 000 g/mol.

14. The composition according to claim 1, wherein the said copolymer (i) is obtained by radical polymerization of:
the following monomers only:
a. acrylic acid,
b. at least one β-carboxyethyl (meth)acrylate monomer,
c. at least one alkyl (meth)acrylate monomer, said alkyl radical comprising from 1 to 12 carbon atoms,
d. at least one hydrophobic non-acrylic monomer,
e. at least one (C₁-C₁₂)alkyloxy polyethylene glycol (meth)acrylate monomer, and
f. optionally methacrylic acid,
in the presence of a free-radical polymerization initiator.

15. The composition according to claim 1, characterized in that the agricultural materials are chosen from pesticides, antimicrobials, nutrients, biostimulants, plant growth regulators, and mixtures thereof.

16. The composition according to claim 1, characterized in that the composition is aqueous.

17. A method of dispersing the copolymer (i) as defined in claim 1, as a dispersant in an agrochemical composition comprising at least one agricultural material.

18. A method for treating soils, plants and/or seeds to control pests and/or regulate the growth of plants comprising applying the agrochemical composition as defined in claim 1 at least one plant, area adjacent to a plant, soil adapted to support growth of a plant, root of a plant, foliage of a plant, and/or seed adapted to produce a plant.
